(19) United States
(12) Patent Application Publication
(10) Pub. No.: US 2004/0113731 A1
(43) Pub. Date: Jun. 17, 2004

(54) Electromagnetic valve system

(76) Inventors: David Moyer, Hanover, NH (US); George Schwartz, Ann Arbor, MI (US); Kevin Morrison, Ann Arbor, MI (US)

Correspondence Address: GLENN PATENT GROUP, 3475 EDISON WAY, SUITE L, MENLO PARK, CA, 94025, US

(21) Appl. No.: 10/674,743

(22) Filed: Sep. 29, 2003

Related U.S. Application Data
(60) Provisional application No. 60/417,264, filed on Oct. 9, 2002.

(51) Int. Cl. H01F 7/08

(52) U.S. Cl. 335/220

(57) ABSTRACT

Systems are provided for electromagnetic actuation of a valve mechanism. A valve is linearly moveable between a first closed position and a second open position. A first spring is compressed when the valve is in the first closed position, and a second valve spring is compressed when the valve is in the second open position. An electromagnetic actuation assembly and a permanent magnet is combined with the valve, such that the valve is latchable in either a closed or open position, and is readily movable between positions through application of energy to the electromagnetic circuitry. The electromagnetic circuitry is controllable to increase or decrease the local magnetic flux, such as to promote movement of the valve, or to provide a soft landing of the valve at either end of movement. Some system embodiments provide energy recovery, feed back, and/or feed forward sensing and control. The electromagnetic valve system can be implemented for a wide variety of engines, valves and actuators, such as for variable valve timing, valve disablement, and/or hybrid engine and energy storage applications.

### CROSS-REFERENCE TO RELATED APPLICATIONS

This application claims priority to U.S. Provisional Patent Application 60/417,264, filed 09 Oct. 2002.

### FIELD OF THE INVENTION

The invention relates to the field of internal combustion engines. More particularly, the invention relates to a structure and process for the controlled movement, latching and/or disablement of valves.

### BACKGROUND OF THE INVENTION

The poppet valve driven by a camshaft has been used in internal combustion engines for many years. Modifications to the valve train have been developed to permit changing the valve timing while the engine is in operation. When the timing control prevents the valves from opening during an engine cycle, the cylinder is disabled, and the effect of a variable displacement engine is obtained. The advantage of a variable displacement engine is that when less than maximum efficiency power is required, some of the cylinders may be disabled and the remaining active cylinders' power is increased so that they operate at greater efficiency, while the engine output remains constant. This approach has had limited success in practice because the usual control activates or deactivates half the number of cylinders, and this abrupt change in output torque causes poor drivability. Furthermore, the disabling mechanism is relatively slow acting, so that more than one revolution of the crankshaft is required to make the change.

While some electromagnetic valve mechanisms have been implemented to operate valves, the energy required to operate the system is typically prohibitive. Energy is often required to retain a valve in either an open or a closed position. Furthermore, the mass of the valve train in such systems is typically substantial, and the movement and landing of componentry is often problematic.

D. Moyer, Cam Activated Electrically Controlled Engine Valve, U.S. Pat. No. 6,302,069, 16 Oct. 2001, describes “an engine valve control responsive to electrical signals from a controller to open and close a valve. Power to move the valve comes from a camshaft. A disabler spring is compressed by a cam lobe and held compressed by its solenoid while the valve is held from opening by its solenoid. When the valve solenoid releases the valve, a half oscillation between the disabler spring and valve spring opens the valve and the valve solenoid than holds it open. The disabler solenoid then releases the disabler spring. When the valve solenoid releases its spring, a half oscillation of the two springs closes the valve with a soft landing. The valve operation is very fast, independent of engine speed, and can be controlled over 630 crankshaft degrees. The camshaft may run at crankshaft speed with valve disablement during compression and expansion strokes for 4 stroke operation. 2 stroke operation may be used for compressor and air motor operation as a pneumatic hybrid engine.”

D. Moyer, Fast Acting Engine Valve Control with Soft Landing, U.S. Pat. No. 6,302,068, 16 Oct. 2001, describes “an engine valve control responsive to electrical signals from a controller to open and close valves. Power to move the valves comes from a conventional camshaft. A disabler spring is compressed by a cam lobe and held compressed by a first solenoid, and the valve is held from opening by a second solenoid. When the second solenoid releases the valve, a ½ oscillation between the disabler spring and valve spring opens the valve and a third solenoid holds the valve open. The first solenoid then releases the disabler spring. When the third solenoid releases the valve spring, a ½ oscillation of the two springs closes the valve with a soft landing and the second solenoid again holds the valve closed. The valve operation is very fast, independent of engine speed, and can be controlled over 270 crankshaft degrees. The solenoids, used for holding only, are very small and require little power. The camshaft runs at crankshaft speed. By disabling the cylinders during compression and expansion strokes, 4 stroke operation is used for gasoline motor operation. 2 stroke operation is used for compressor and air motor operation as a pneumatic hybrid.”

D. Moyer, Engine Valve Disabler, U.S. Pat. No. 6,260,525, 17 Jul. 2001, describes “A method for improving efficiency and reducing emissions of an internal combustion engine. Variable displacement engine capabilities are achieved by disabling engine valves during load changes and constant load operations. Active cylinders may be operated at minimum BSFC by intermittently disabling other cylinders to provide the desired net torque. Disabling is begun by early closing of the intake valve to provide a vacuum at BDC which will result in no net gas flow across the piston rings, and minimum loss of compression energy in the disabled cylinder; this saving in engine friction losses is significant with multiple disablements.” The device described in the '525 patent provides a foundation for the invention disclosed herein.

D. Moyer, Fuel Efficient Valve Control, U.S. Pat. No. 5,975,052, 02 Nov. 1999, describes “A method for improving efficiency and reducing emissions of an internal combustion engine. Variable displacement engine capabilities are achieved b y disabling engine valves during load changes and constant load operations. Active cylinders may be operated at minimum BSFC by intermittently disabling other cylinders to provide the desired net torque. Disabling is begun by early closing of the intake valve to provide a vacuum at BDC which will result in no net gas flow across the piston rings, and minimum loss of compression energy in the disabled cylinder; this saving in engine friction losses is significant with multiple disablements.

E. Lohse and U. Muller, Electromagnetic Actuator for a Cylinder Valve Including an Integrated Valve Lash Adjuster, U.S. Pat No. 6,047,673, 11 Apr. 2000, describe “An electromagnetic actuator for operating an engine valve of an internal-combustion engine includes two electromagnets; an armature movably disposed in the space between the electromagnets for reciprocation in response to electromagnetic forces generated by the electromagnets; resetting springs operatively coupled to the armature for opposing armature motions effected by the electromagnetic forces; a push rod affixed to the armature for moving therewith as a unit; and a guide for guiding the push rod. The guide includes a guide cylinder and a push-rod piston carried by an end of the push rod. The push-rod piston is slidably received in the guide cylinder. A setting piston is slidably received in the guide cylinder and defines, with the push-rod piston, an intermediate chamber forming part of the cylinder. The setting piston has an end adapted to be operatively coupled to the engine valve. A fluid supply introduces hydraulic fluid into the intermediate chamber. Further, a fluid-control valve is provided which has an open state in which the intermediate chamber communicates with the fluid supply and a closed state in which hydraulic fluid is locked in the intermediate chamber for rigidly transmitting motions of the push-rod piston to the setting piston.

M. Theobald, B. Lequesne, and R. Henry, Control of Engine Load via Electromagnetic Valve Actuators, Paper No. 940816, International Congress & Exposition, Detroit, Mich., Feb. 28—Mar. 3, 1994, describes a single-cylinder research engine equipped with programmable valve actuators. The actuators include a permanent magnet “that eliminates the need for a holding current while the valve is fully open or closed.

F. Pischinger and P. Kreuter, Electromagnetically Operating Actuator, U.S. Pat. No. 4,455,543, 19 Jun. 1984, describe “An electromagnetically operating actuator for control elements capable of making oscillatory movements in displacement machines, more particularly for flat slide shut-off valves and lift valves, includes a spring system and a pair of electrically operating switching elements, over which the control element is moveable in two discrete opposite operating positions and is retained thereat by either switching magnet, the locus of the position of equilibrium of the spring system lying between the two operating positions. The invention is characterized by the provision of a compression device in engagement with the spring system for relocating the locus of the position of equilibrium of the spring system upon actuation of the compression device.”

D. Bonvallet, Variable Lift Electromagnetic Valve Actuator System, U.S. Pat. No. 4,777,915, 18 Oct. 1988, describes a “housing on the cylinder head of an engine operatively supports an upper solenoid and a tubular lower solenoid such that therein working pole faces are opposed to each other for operatively effecting movement of an armature fixed to the free stem end of a poppet valve having its stem extending up through the lower solenoid. Upper and lower springs each have one end thereof positioned in the upper and lower solenoids, respectively, and the lower solenoid has an actuator operatively connected thereto to effect axial position of the lower solenoid, while the upper solenoid has a lash adjuster operatively associated therewith.”

N. Miyoshi; K. Ohtsubo, Electric Valve Drive Device in an Internal Combustion Engine, U.S. Pat. No. 5,983,847 16 Nov. 1999, describes a “poppet valve is provided to open and close a valve seat in an internal combustion engine. At the end of a valve stem of the valve, a cylindrical support is fixed, and on the outer circumferential surface of the support, a moving coil is wound. There is formed an annular cavity in a yoke fixed to a bracket fixed on a cylinder head, and a permanent magnet is fixed in the annular cavity of the yoke. Between the permanent magnet and the yoke in the annular cavity, the support which has the moving coil is inserted. By a control system having CPU, an electric current is applied to the moving coil, thereby providing optimum valve timing and lift to decrease seating noise and improving engine performance.”

B. Patel, Permanent Magnet Bistable Solenoid Actuator, U.S. Pat. No. 4,533,890, 06 Aug. 1985, describes a “bistable actuator comprising a permanent magnet assembly secured to an armature shaft and a pair of core elements axially disposed on either side of the permanent magnet assembly. The cores have axially opposed inner and outer annular extensions defined in each core by a central axial opening which supports the armature shaft and an annular recess in which is received an electrical coil. The permanent magnet assembly comprises inner and outer annular axially magnetized permanent magnets radially spaced by a ferromagnetic ring so as to be aligned with the inner and outer core extensions.”

B. Lequesne, Variable lift operation of bistable electromechanical poppet valve actuator, U.S. Pat. No. 4,829,947, 16 May 1989, “A valve actuating device for an internal combustion engine is operated with partial valve lift. The valve is spring biased toward a neutral central position but held in full open or closed positions by permanent magnets having associated coils. Normal activation of the valve between full open and closed positions is by activation of a coil to fully cancel the field of the associated magnet with a spring moving the valve to the other position. Partial lift operation comprises providing, with the valve in its closed position, a valve opening current to the valve opening coil to reduce the closing magnetic field but stopping the current before the valve reaches its full open position and providing a valve closing current to one of the coils to cause the return of the valve to its closed position. Two modes of partial lift operation are described: a first in which valve movement is continuous with valve opening duration substantially proportional to valve lift and a second in which the valve is moved to a stable half lift position, left in this position for an arbitrary duration, and pulled back into the closed position.”

While other prior art valve systems which use electromagnetic force to move a valve, there is no provision to promote eliminate or reduce a hard landing, which typically results in extremely short valve life.

It would be advantageous to mass produce an electromechanical valve system which is latchable without applied energy in either an open or a closed position. Such a system would be a major technological breakthrough. Furthermore, it would be advantageous to provide an electromechanical valve system which allows a soft landing at either end of movement. Such a system would be a further technological breakthrough. As well, it would be advantageous to provide an electromechanical valve system which is readily controllable to increase or decrease the local magnetic flux, such as to promote movement of the valve, or to provide a soft landing of the valve at either end of movement. In addition, it would be advantageous to provide an electromechanical valve system which provides energy recovery, feed back, and/or feed forward sensing and control. Such a system would be a further technological breakthrough.

### SUMMARY OF THE INVENTION

Systems are provided for electromagnetic actuation of a valve mechanism. A valve is linearly moveable between a first closed position and a second open position. A first spring is compressed when the valve is in the first closed position, and a second valve spring is compressed when the valve is in the second open position. An electromagnetic actuation assembly and a permanent magnet is combined with the valve, such that the valve is latchable in either a closed or open position, and is readily movable between positions through application of energy to the electromagnetic circuitry. The electromagnetic circuitry is controllable, for example, to increase or decrease the local magnetic flux, such as to promote movement of the valve, or to provide a soft landing of the valve at either end of movement. Some system embodiments provide energy recovery, feed back, and/or feed forward sensing and control. The electromagnetic valve system can be implemented for a wide variety of engines, valves and actuators, such as for variable valve timing, valve disablement, and/or hybrid engine and energy storage applications.

### BRIEF DESCRIPTION OF THE DRAWINGS

FIG. 1 is a partial cross sectional view of an electromagnetic valve system;

FIG. 2 is a top schematic view of a permanent magnet clapper;

FIG. 3 is a partial cutaway view of a Model 1 single solenoid magnetic valve control system;

FIG. 4 is a first cutaway view of an electromagnetic valve actuation system comprising discrete spring and electromagnet assemblies;

FIG. 5 is a second cutaway view of an electromagnetic valve actuation system comprising discrete spring and electromagnet assemblies;

FIG. 6 is a top schematic view of an electromagnetic valve actuation system comprising discrete spring and electromagnet assemblies;

FIG. 7 is a first cutaway view of a preferred electromagnetic valve actuation system comprising discrete spring and electromagnet assemblies;

FIG. 8 is a second cutaway view of a preferred electromagnetic valve actuation system comprising discrete spring and electromagnet assemblies;

FIG. 9 is a schematic view of an electromagnetic valve system having a reciprocating disk clapper comprised of a ferrous or magnetic material;

FIG. 10 is a schematic view of an electromagnetic valve system which comprises a permanent magnet reciprocating disk clapper;

FIG. 11 is a schematic view of a controller and power module linked to an electromagnetic valve system;

FIG. 12 is a detailed schematic view of control and power circuitry associated with an electromagnetic valve system;

FIG. 13 is a schematic of the transistor circuitry used to energize the electromagnets and control valve position;

FIG. 14 is a detailed cross-sectional view of a mechanical spring disabler mechanism;

FIG. 15 is a detailed partial cross-sectional view of a mechanical valve disabler system in a first position with a disabler set;

FIG. 16 is a detailed partial cross-sectional view of a mechanical valve disabler system in a second disabled position with a disabler set;

FIG. 17 is a detailed partial cross-sectional view of a mechanical valve disabler system in a first enabled and closed position;

FIG. 18 is a detailed partial cross-sectional view of a mechanical valve disabler system in a second enabled and opened position;

FIG. 19 is a detailed partial cross-sectional view of an alternate mechanical valve disabler system in a first position with a disabler set;

FIG. 20 is a detailed partial cross-sectional view of an alternate mechanical valve disabler system in a second disabled position with a disabler set;

FIG. 21 is a detailed partial cross-sectional view of an alternate mechanical valve disabler system in a first enabled and closed position;

FIG. 22 is a detailed partial cross-sectional view of an alternate mechanical valve disabler system in a second enabled and opened position;

FIG. 23 is a partial detailed cutaway view of a spring latch mechanism;

FIG. 24 is a profile view of a reverse profile cam lobe;

FIG. 25 is a partial cutaway vie w of an alternate electromagnetic valve system; and

FIG. 26 is an end view of an alternate electromagnetic valve system.

### DETAILED DESCRIPTION OF PREFERRED EMBODIMENTS

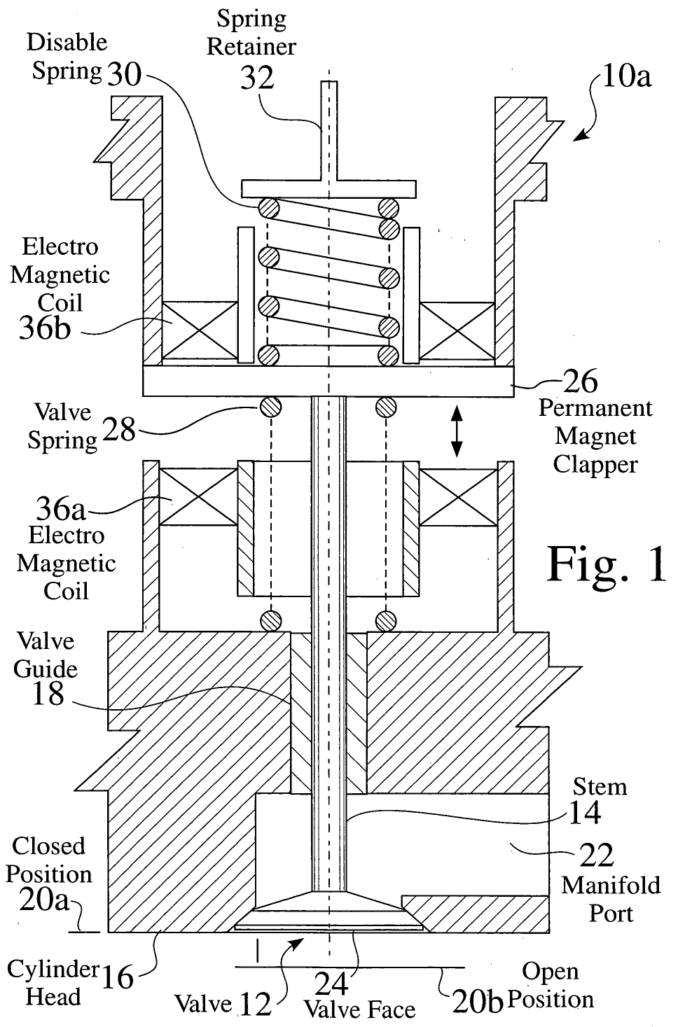

FIG. 1 is a partial cross sectional view of an electromagnetic valve system 10a. A valve 12, having a stem 14, is linearly moveable within a cylinder head 16, such as through a valve guide 18. The valve 12 is linearly moveable between a closed position 20a and an open position 20b, to allow flow into or out of a manifold port 22.

The valve 12 comprises a valve face 24 at one end of the stem 14. A clapper 26 is affixed to the stem 14, such that movement of the clapper results in movement of the valve 12. A valve spring 28 is located between the head 16 and the clapper 26, which biases the valve 12 toward a closed position 20a. A disable spring 30 is located on an opposing surface of the clapper 26, to bias the valve 12 toward an open position 20b. The disable spring 30 is typically affixed in relation to the cylinder head 16, such as by a retainer 32.

A first electromagnet 36a is located on one side of the clapper 26, and a second electromagnet 36b is located on the opposing side of the clapper 26. In a closed position 20a, the magnetic flux of the permanent magnet clapper 26 provides an attractive magnetic force to retain the clapper 26, such as to latch the valve 12 in the closed position 20a. Similarly, in an open position 20b, the magnetic flux of the permanent magnet clapper 26 provides an attractive magnetic force to retain the clapper 26, such as to latch the valve 12 in the open position 20b.

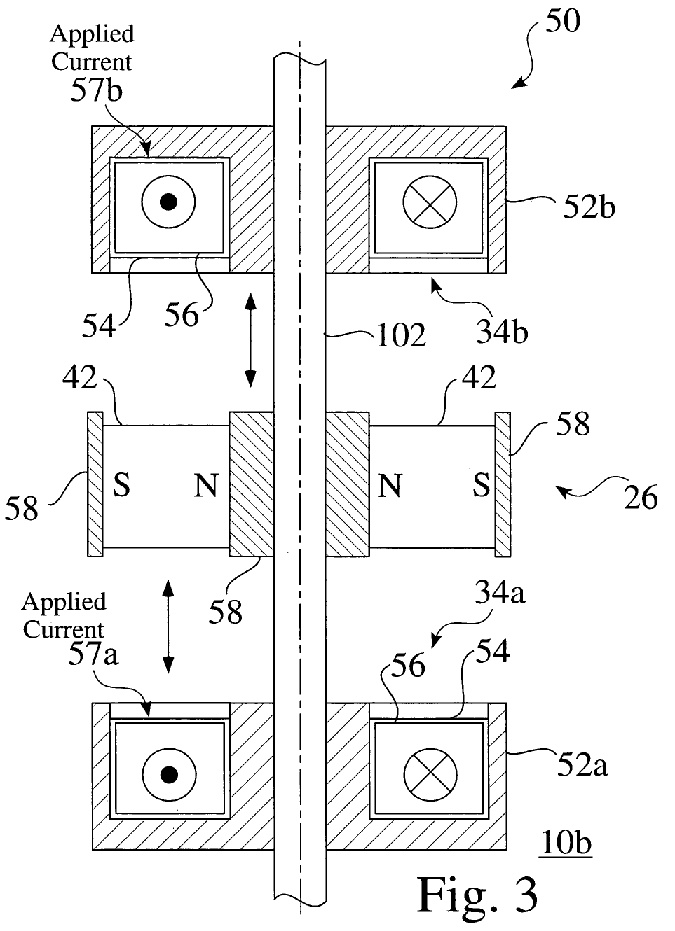

The electromagnetic coils 36a,36b typically comprise a toroidal core 56 (FIG. 3), around which electrically conductive wire 54 is wound. Electrical current 57 (FIG. 3) is controllably applied in either direction, such as through the wire 54, such that the electromagnetic coils 36a,36b are operable to provide a magnetic flux in either vertical direction.

In operation, the electromagnetic valve system 10a is readily moveable between positions 20a,20b. Applied energy to the electromagnets 36 acts to increase or decrease the total magnetic attraction of the clapper 26.

From a closed position 20a, applied energy to the second electromagnetic coil 36b provides a magnetic flux in a generally opposite direction to the magnetic flux from the permanent magnet clapper 26. In the closed position 20a, the disable spring 30 comprises more stored potential energy than valve spring 28. When the total magnetic force acting on clapper 26 becomes less than the force from the potential energy difference between springs 30 and 28, the clapper 26 and valve 12 move downward toward the open position. As the clapper moves, the disable spring 30 expands and the valve spring 28 is compressed. As the valve approaches the open position 20b, the magnetic flux of the permanent magnet clapper 26 provides an attractive magnetic flux. The first electromagnetic coil 36a may preferably be energized as the valve approaches the open position 20b, such as to increase the attractive, i.e. pulling, magnetic force 82.

In addition, the first electromagnetic coil 36a may preferably be energized near the end of travel, as the valve 12 approaches the open position 20b, such as to slow the advance of the clapper 26, and provide a soft landing in the open position 20b. The magnetic flux provided by some permanent magnets 34 increases significantly at short distances, such as to increase the attractive, ie. pulling, magnetic force. Activation of the electromagnetic coil 36a to provide a soft landing typically comprises a short time period, such as a pulse, to slow the approach of the clapper 26.

Similarly, from an open position 20b, applied energy to the first electromagnetic coil 36a provides a magnetic flux in a generally opposite direction to the magnetic flux from the first permanent magnet clapper 26. In the open position 20b, the valve spring 28 comprises stored potential energy. When the total magnetic force becomes less than the force from the potential energy, the clapper 26 and valve 12 move linearly upward toward the closed position 20a. As the clapper 26 contacts the disable spring 30, the disable spring 30 is compressed. As the valve 12 approaches the closed position 20a, the magnetic flux of the second permanent magnet 34b provides an attractive magnetic flux. The second electromagnetic coil 36b may preferably be energized as the valve 12 approaches the closed position 20a, such as to increase the attractive, i.e. pulling, magnetic force.

In addition, the second electromagnetic coil 36b may preferably be energized near the end of travel, as the valve 12 approaches the closed position 20a, such as to slow the advance of the clapper 26, and provide a soft landing in the closed position 20a.

Activation of the electromagnetic coil 36a to provide a soft landing typically comprises a short time period, such as a pulse, to slow the approach of the clapper 26.

In some embodiments of the electromagnetic valve system 10, the clapper comprises one or more permanent magnets 42. In alternate embodiments of the electromagnetic valve system 10, the clapper comprises magnetically attractive, i.e. ferrous material.

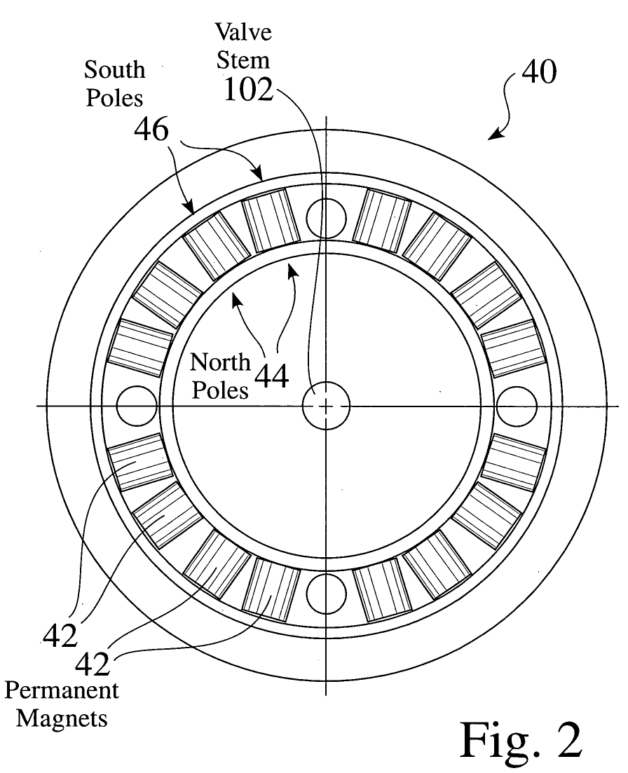

FIG. 2 shows a partial detailed top view of a clapper 26 comprising a plurality of radially aligned permanent magnets 42. As seen in FIG. 2, each of the magnets 42 is radially aligned toward the valve stem 14, wherein the north poles 44 face inward, and wherein the south poles 46 face outward.

FIG. 3 is a partial cutaway view of a Model 1 single solenoid magnetic valve control system 10b, in which a permanent magnet clapper 26a is affixed to the stem 14 of a valve, and is moveable between a first electromagnet 34a and a second electromagnet 34b. The electromagnetic coils 34a,34b are located within yoke assemblies 52a,52b, and comprise wire coils 54 on a core 56. The clapper 26 comprises a magnetic region 42 within a clapper yoke 58.

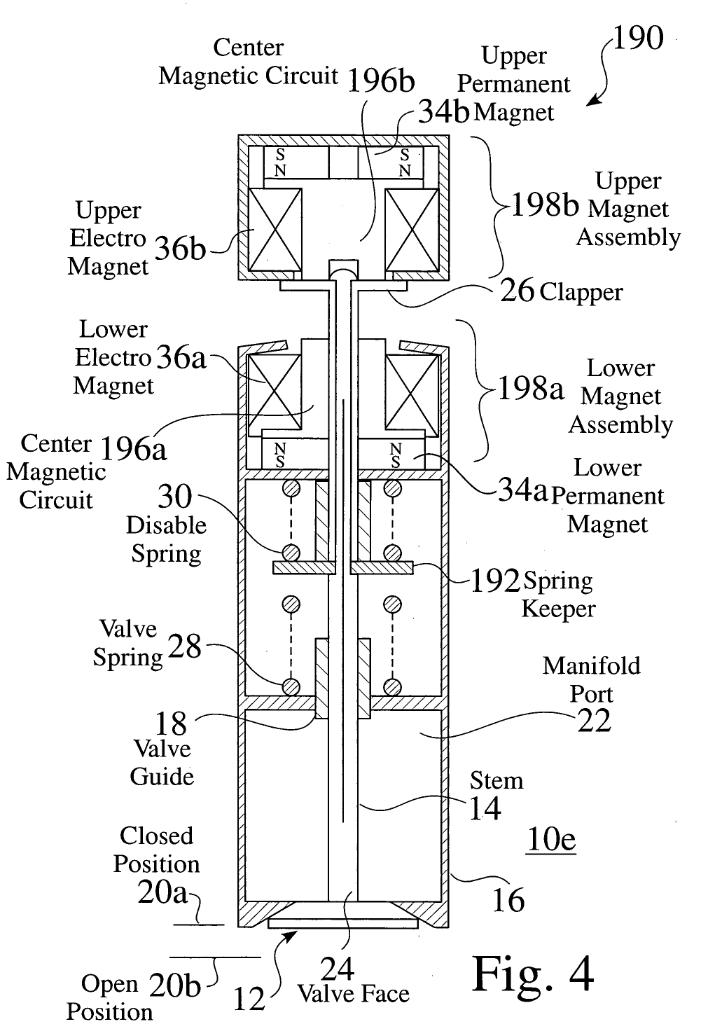

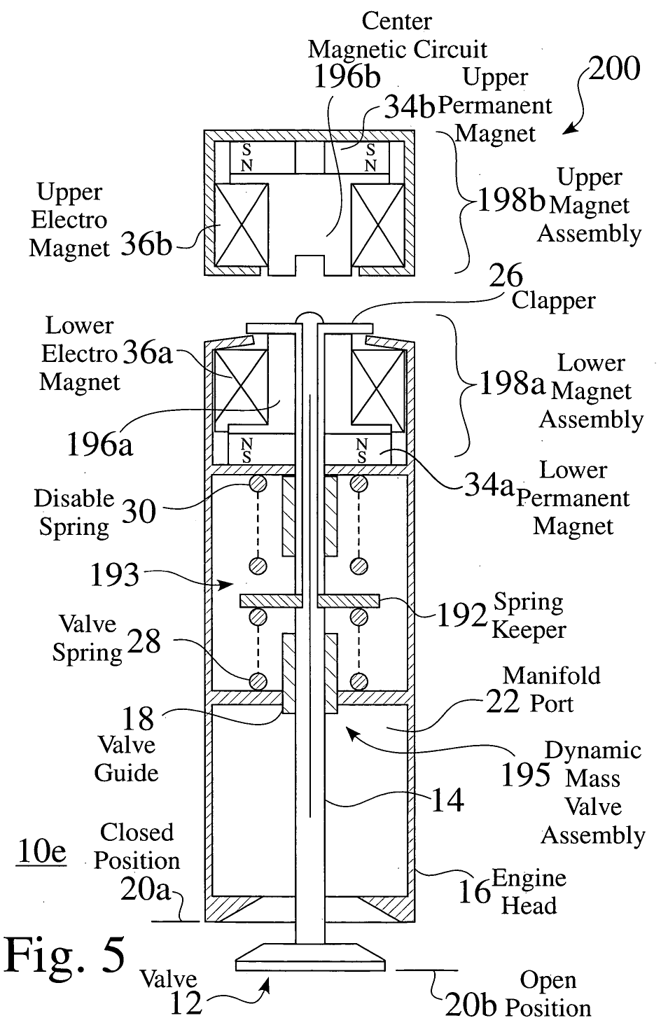

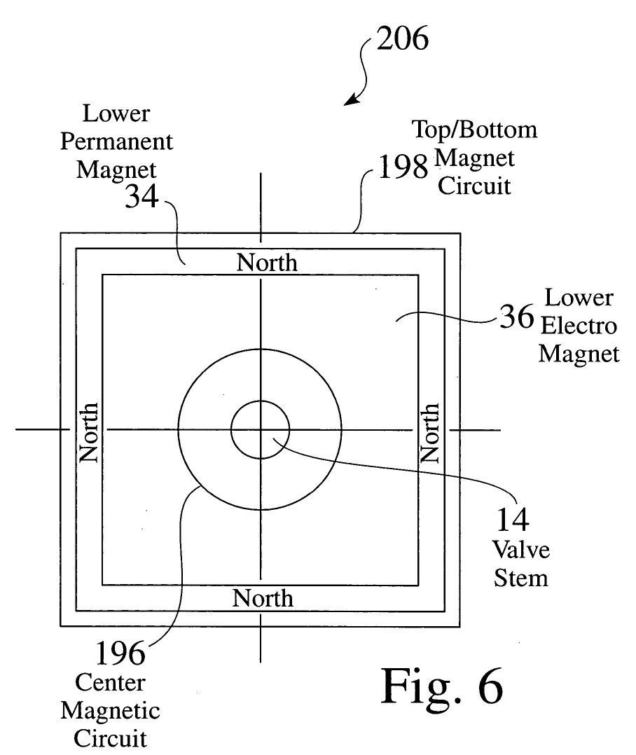

FIG. 4 is a first cutaway view 190 of an electromagnetic valve actuation system 10e comprising discrete spring and electromagnet assemblies, with the valve 12 in a closed position 20a. FIG. 5 is a second cutaway view 200 of an electromagnetic valve actuation system 10e comprising discrete spring and electromagnet assemblies, with the valve 12 in an open position 20b. FIG. 6 is a top schematic view 206 of an electromagnetic valve actuation system 10e comprising discrete spring and electromagnet assemblies 198a, 198b.

A spring keeper 192 affixed to the valve stem 14 moves linearly to transfer energy between the disable spring 30 and the valve spring 28. A clapper 26 affixed to the valve stem 14 moves between an upper magnet assembly 198b and a lower magnet assembly 198a. The upper magnet assembly 198b comprises an upper permanent magnet 34b and an upper electromagnet 36b, while the lower magnet assembly comprises a lower permanent magnet 34a and a lower electromagnet 36a.

As seen in FIG. 4 and FIG. 5, the springs 28,30 are preferably fastened at the far bearing ends, and are not fastened to the spring keeper 192, such that the springs 28,30 are preferably isolated from the dynamic mass of the valve system 10e during a portion of the valve movement. In one exemplary embodiment, the springs 28,30 are rated at 660 lbs./per inch. In the electromagnetic valve system 10e, the valve stem shaft is non-magnetic. The clapper 26 shown in FIG. 4 and FIG. 5 also comprises a mechanical sleeve 195, such as to accurately affix the clapper 26 to the valve stem 14.

The permanent magnets 34a,34b provide a latching means for the clapper 25, in either the closed position 20a or the open position 20b. As seen in FIG. 5, the permanent magnet 34a holds the valve spring 28 compressed in the valve open position 20b, whereby the valve spring 28 retains a high level of potential energy. Similarly, as seen in FIG. 4, the permanent magnet 34b holds the disable spring 30 compressed in the valve closed position 20a, whereby the disable spring 30 retains a high level of potential energy.

From the closed position 20a, wherein the clapper 26 is latched against the upper magnet assembly 198b, an applied energy to the upper electromagnet 36b is controllably energized to release the clapper from the closed position 20a. Upon activation of energy to the first electromagnet 36b, an electromagnetic flux is generated by the electromagnet 36b, which opposes the permanent magnet flux of the upper permanent magnet 34b. When the applied opposing electromagnetic flux reduces the permanent magnet holding force below that of the spring force applied by the disable spring 30, the valve 12 begins to open.

As the valve 12 begins to open, the applied force of the upper permanent magnet 34b, which has a constant flux, is reduced. As the valve 12 opens and the clapper 26 moves away from the upper magnet assembly 198b, whereby the applied flux density from the permanent magnet 34b falls off very rapidly, such that the attractive force decreases rapidly.

Similarly, as the valve 12 begins to close, the applied force of the lower permanent magnet 34a, which has a constant flux, is reduced. As the valve 12 closes and the clapper 26 moves away from the lower magnet assembly 198b, the applied flux density from the permanent magnet 34a falls off very rapidly, such that the attractive force decreases rapidly.

As the spring keeper 192 moves and advances toward the middle region 193, the spring forces are equal, and the kinetic energy of the system reaches a maximum. The spring keeper 192 continues to move, whereby the kinetic energy of the moving mass of the assembly 195 is converted to stored potential energy in the valve spring 28. The moving mass of the assembly 195 is typically equal to the combined mass of the clapper 26, the valve 12, the keeper 192, and at least a portion of the springs 28,30.

In preferred embodiments of the electromagnetic actuation system 10, the kinetic mass of the valve train 195 is minimized by the configuration of the valve spring 28 and the disable spring 30, whereby kinetic energy is transferred between the valve spring 28 and the disable spring 30, in a central region 193 of movement, and whereby the mass of either the first or second spring 28,30 is substantially isolated from the effective mass of valve train 195 for most of the movement.

For example, as seen in FIG. 4 and FIG. 5, as the spring keeper 192 moves beyond the central region 193, the valve spring 28 is compressed by further downward movement of the valve assembly 195, comprising the clapper 26, the valve 12, and spring keeper 192, while the disable spring 30 becomes isolated from the assembly 195 (FIG. 5).

When the valve assembly 195 approaches the end of travel, e.g. such as toward an open position 20b, the valve 12, clapper 26, and spring keeper 192 decelerate, as the kinetic energy of the valve assembly 195 is transformed to stored potential energy in the valve spring 28. Near the limit of travel, the applied flux from the lower permanent magnet 34a provides an attractive force to latch the valve 12 in the open position 20b.

As described above, the attractive force from between the permanent magnets 34 and the electromagnets 36 is proportional to the displacement distance, i.e. there is a strong attractive force at the very end region of travel. In preferred embodiments of the invention, therefore, energy may be controllably applied to the approaching electromagnet 36, to promote a ‘soft’ landing.

When the spring keeper 192 compresses the valve spring 28 to the bottom limit of movement, i.e. as the clapper 26 approaches the lower magnet assembly 198a, the clapper 26 contacts and latches to the lower magnet assembly 198a because the magnet force increases as the clapper 26 approaches the magnet assembly 198a. At the limit of travel, the magnetic holding force is larger than the opposing valve spring force, such that the valve 12 latches in the open position 20b.

In the electromagnetic valve system 10e shown in FIG. 4 and FIG. 5, the valve 12 latches in either the closed position 20a or in the open position 20b, without the application of energy.

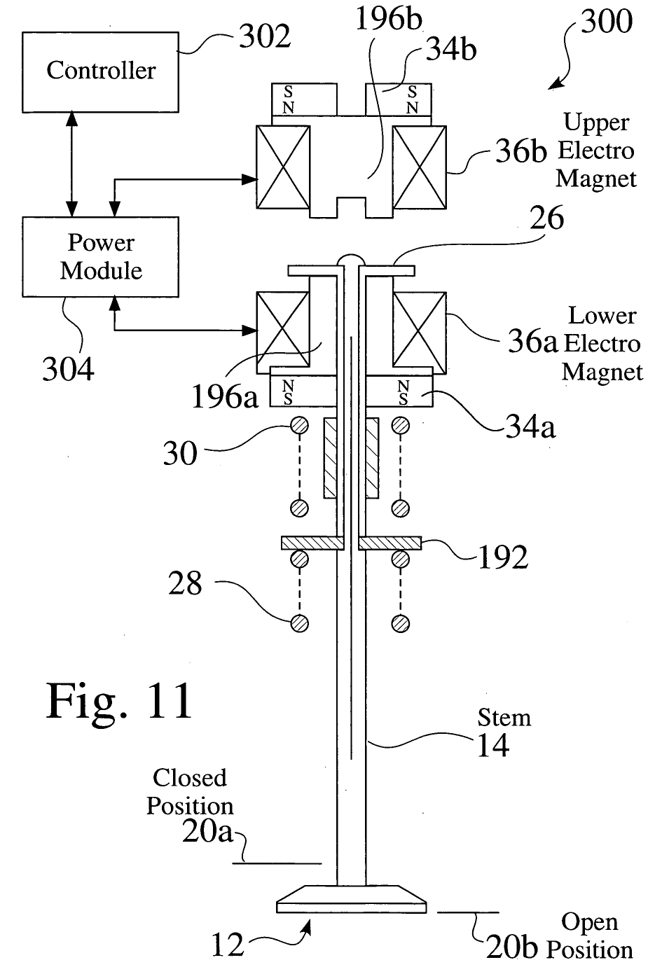

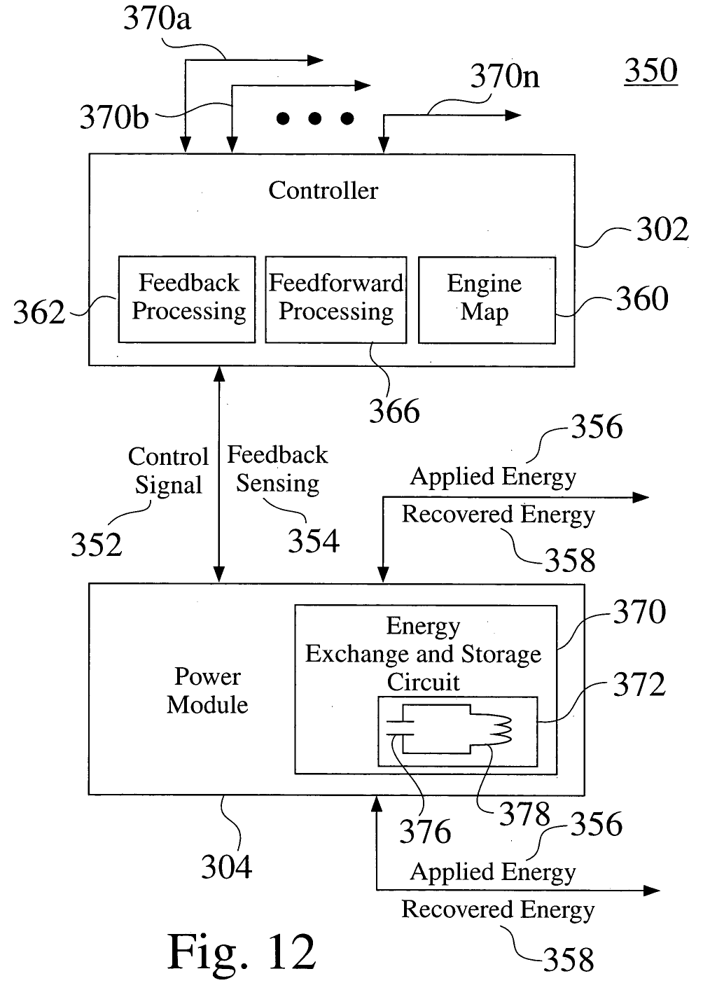

Release from either latch condition is controllable through applied energy signal, such as from an external control 302 (FIG. 11, FIG. 12). As seen in FIG. 12, an external controller 302 sends a signal, i.e. energy pulse, to the appropriate magnet assembly 198a/b, which is latched to the clapper 26. The applied pulse overcomes the permanent magnet attraction force, such that the compressed spring, e.g. the valve spring 28, acts upon the assembly 195 (FIG. 5), which moves toward the opposite position.

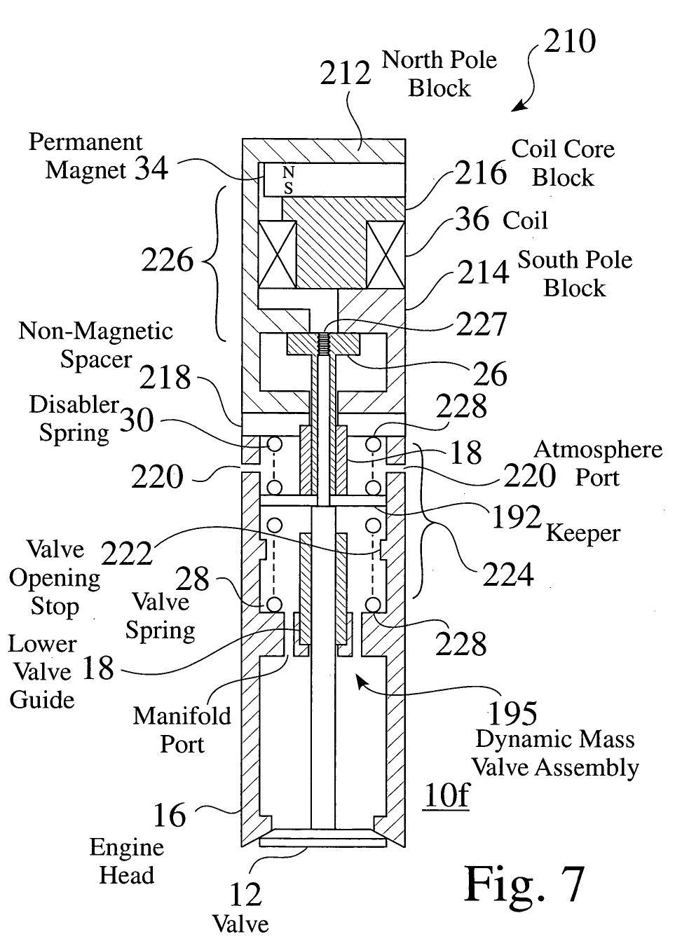

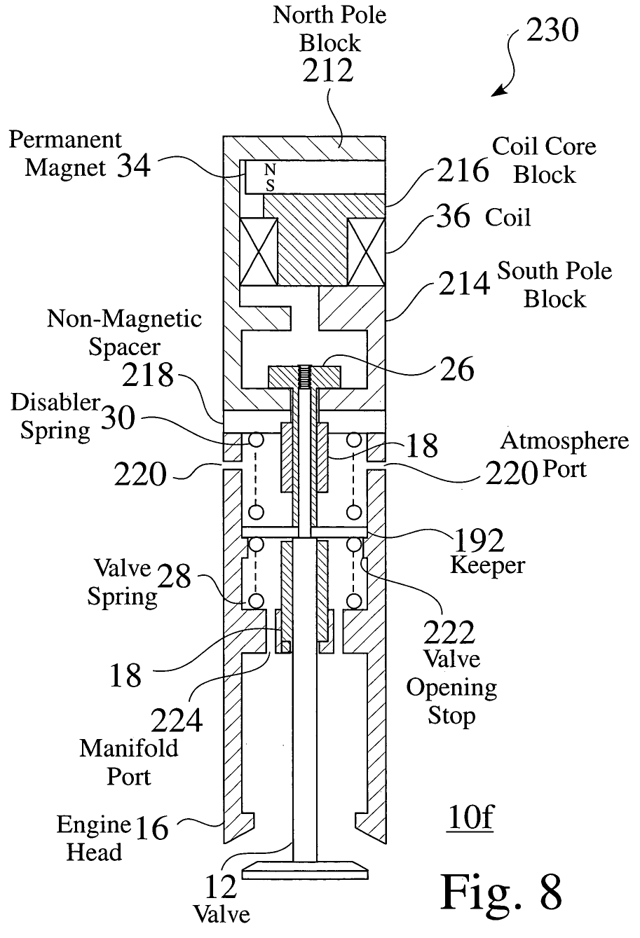

FIG. 7 is a first cutaway view 210 of a preferred electromagnetic valve actuation system 10f comprising discrete spring 224 and electromagnet 226 assemblies, in a closed position 20a. FIG. 8 is a second cutaway view of a preferred electromagnetic valve actuation system 10f comprising discrete spring 224 and electromagnet 226 assemblies, in an open position 20b. The electromagnetic valve actuation system 10f comprises a single axially polarized, non-moving permanent magnet 34, and a single electromagnet and coil 36.

The spring assembly 224 comprises two separate springs 28,30, which act independently, i.e. the springs 28,30 are alternately isolated from the dynamic mass of the valve assembly 195, which reduces the spring moving mass, and reduces spring friction.

The permanent magnet 34 is preferably square or rectangular, in horizontal cross section, to provide an increased magnetic flux over the footprint of the cylinder head 16. The square or rectangular permanent magnet 34 has more flux than a round one of equal diameter, which allows springs 28,30 having higher spring forces to be used.

The electromagnetic valve actuation system 10f also preferably comprises full width magnet poles 212,214, to carry more magnetic flux. The clapper 26 is typically cylindrical in profile, to allow rotation of the valve 12.

In the exemplary embodiment shown in FIG. 7 and FIG. 8, the valve stem 14 screws into the clapper 26, and is preferably held with a locking compound 227, such as LOCTITE™, such that the spring keeper 192 is mechanically affixed to the valve assembly 195. In some system embodiments, the spring keeper 192 acts as a piston, to balance the manifold pressure.

In some system embodiments, the fixed ends 228 of the springs 28,30 are screwed into position, to retain the springs in a perpendicular position, with the vertical forces equally distributed across the springs 28,30. The valve seat and the opening stop 222 stops the keeper 192 near full opening, to provide adjustment for temperature and wear. The free lengths of the springs 28,30 preferably overlap slightly, so that the moving spring mass 195 can transfer kinetic energy at the mid point 193 (FIG. 5).

System Op ration. As seen in FIG. 7, the valve 12 is shown in the closed position 20a. To open the valve 12, the coil 36 is energized to oppose the permanent magnet flux (PMF) and effectively cancel the PMF holding force, which causes the disabler spring 30 force to accelerate the valve 12 in the opening direction 20b.

As the valve 12 moves away from the magnet pole, the PMF decreases, and the opening flux is proportionately decreased, so as to minimize the magnetic force. When the keeper 192 approaches the midpoint 193, the keeper 192 contacts the valve spring 28. The disabler spring 30 delivers itskinetic energy to the valve spring 28, by the time the disabler spring 30 reaches a free length, where the disable spring 30 stops moving. The valve spring 28 absorbs the kinetic energy, and decelerates the moving mass 195 toward the open position 20b.

During the valve motion, friction and windage typically absorb a portion of the kinetic energy, which slows the valve motion. As the clapper 26 approaches the magnetic midpoint (where the PMF goes to zero), the coil 36 voltage reverses, and its amptitude is proportional to the moving mass 195 speed varies with friction, windage, temperature, and cylinder charge. The flux from the coil 36 is then approximately adjusted, so that the keeper 192 arrives at the stop 222 with close to zero speed, and the magnetic force PMF from the permanent magnet 34 holds the valve 12 open 20b.

The controlled movement of the valve system 10f from the open position 20b to the closed position 20a is provided by the reverse of the opening motion. To close the valve 12, the coil 36 is energized to oppose the permanent magnet flux (PMF) and effectively cancel the PMF holding force, which causes the valve spring 28 force to accelerate the valve 12 in the closing direction 20a.

Similarly, as the valve 12 moves away from the magnet pole, the PMF decreases, and the opening 12 flux is proportionately decreased, so as to minimize the magnetic force. When the keeper 192 approaches the midpoint 193, the keeper 192 contacts the disable spring 30. The valve spring 28 delivers kinetic energy to the disable spring 30, by the time the valve spring 28 reaches a free length, where the valve spring 28 stops moving. The disable spring 30 absorbs the kinetic energy, and decelerates the moving mass 195 toward the closed position 20a. As well, the assisting flux from the coil 36 is typically proportionately adjusted, so that the keeper 192 arrives at the top position with close to zero speed, and the magnetic force PMF from the permanent magnet 34 holds the valve 12 closed 20a.

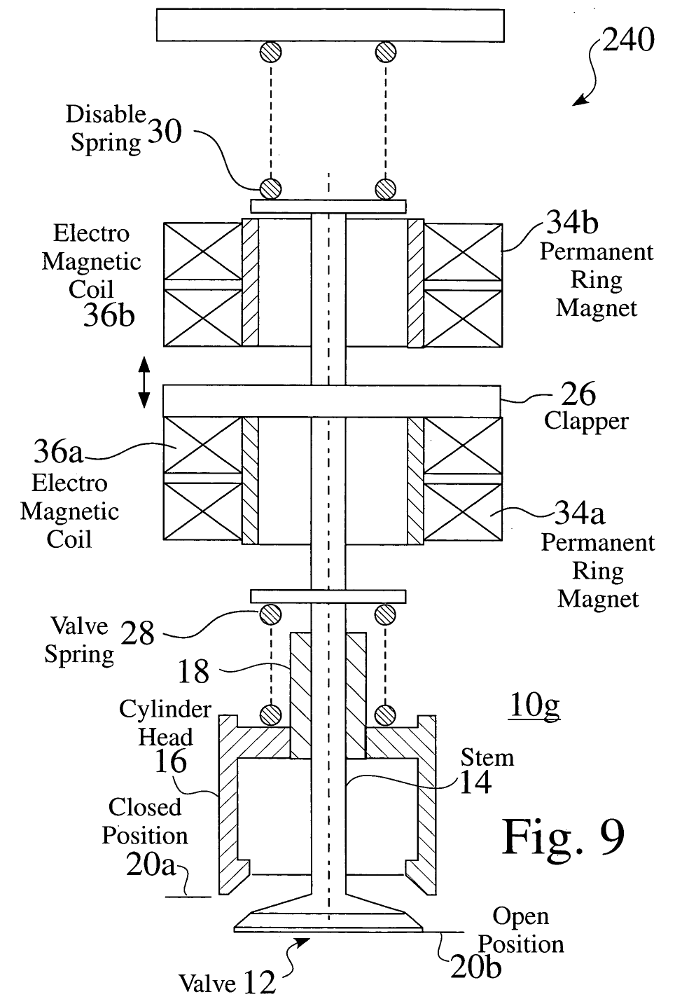

FIG. 9 is a schematic view 240 of an electromagnetic valve system 10g having a clapper 26 comprised of a ferrous or magnetic material, wherein the clapper 26 comprises a reciprocating disk. In some system embodiments, the permanent magnets 34 are integrated within the electromagnets 36, which provides magnetic attraction to the disk 26 without the need for electrical energy.

A “reverse” electrical pulse to the appropriate electromagnet 36, e.g. 36a, cancels the permanent magnet field to cause the release of the disk 26. The springs 28, 30 then force the disk 26 and connected valve 12 to the opposing permanent/electromagnet 34,36. The disk 26 is attracted to the opposing permanent/electromagnet, where it comes to rest.

The electromagnetic valve system 10h provides latching, either open or closed, without requiring power, even after the engine is turned off. Only a brief current pulse is required to cause the valve 12 to switch to the opposing position 20a,20b. Thus, power is only consumed for a brief period. As the permanent magnet clapper 26 approaches the electromagnet 36, the changing magnetic field is preferably converted to electrical energy, to be returned to a power module 304 (FIG. 11, FIG. 12). In some embodiments, the electromagnets 36a,36b additionally repel the clapper 26, such as to provide for fast valve speeds.

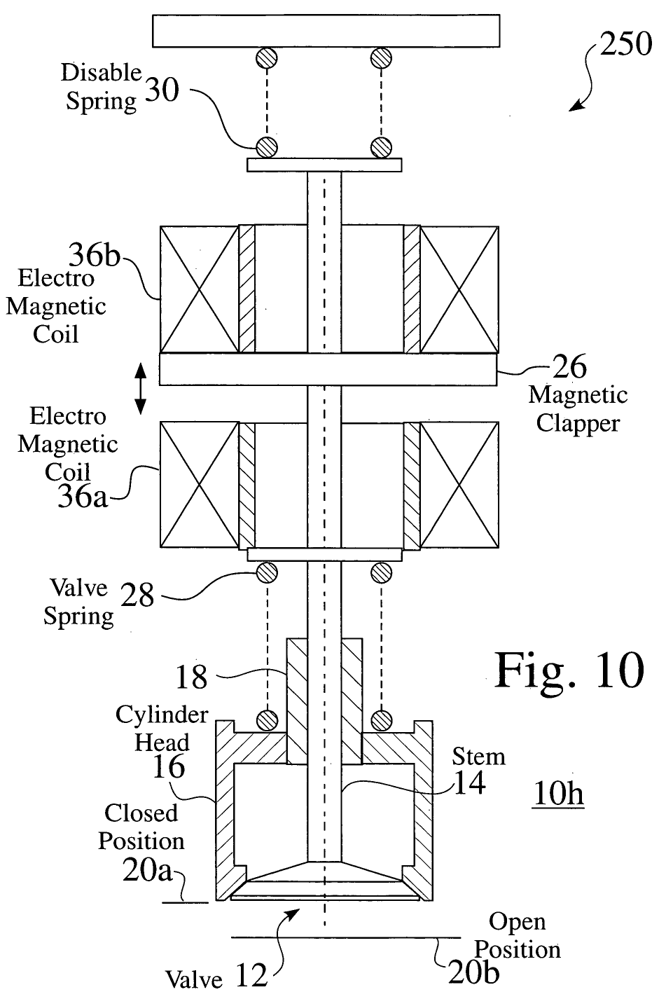

FIG. 10 is a schematic view of an electromagnetic valve system 10h which comprises a permanent magnet clapper 26, wherein the clapper 26 comprises a permanent magnet reciprocating disk. The reciprocating disk clapper 26 is attached to the engine valve 12, such as by a rod that passes through one electromagnet 36. Electromagnets 36a,36b are placed at both ends of the disk travel. The electromagnets 36 have the ability to controllably attract or repel the permanent magnet clapper 26, depending on the direction of the current in the electromagnet 36. When the permanent magnet 36 in not in close proximity to the electromagnet (within approximately 0.05 inches), the only forces acting on the magnet clapper are spring forces. The two springs 28,30 accelerate and decelerate the disk 26 and valve 12 to the opposing valve positions 20a,20b.

The electromagnetic valve system 10h provides latching, either open or closed, without requiring power, even after the engine is turned off. A brief current pulse is required to cause the valve 12 to switch to the opposing position 20a,20b. Thus, power is consumed for a brief period. As the permanent magnet clapper 26 approaches the electromagnet 36, the changing magnetic field is preferably converted to electrical energy, to be returned to an energy exchange and storage system (FIG. 12), e.g. such as a battery or an LC circuit. In some embodiments, the electromagnets 36a,36b additionally repel the permanent magnet clapper 26, such as to provide for fast valve speeds.

The electromagnetic valve system 10h is typically comprises low eddy current, i.e. low loss, materials as well as energy recovery circuitry, will help reduce energy consumption. Some embodiments of the electromagnetic valve system 10h provide soft landing controls, such that the valve 12 and/or disk 26 do not “slam” into other engine parts as the valve comes to rest. The soft landing control typically comprises the provision of a short electrical repelling force to the appropriate electromagnet 36, as the disk 26 approaches. In some system embodiments, at least a portion of the energy required for the soft landing pulse is provided from the energy recovery circuitry.

System Control and Power Circuitry. FIG. 11 is a schematic view 300 of a controller 302 and power module 304 linked to an electromagnetic valve system 10. FIG. 12 is a detailed schematic view 350 of control 302 and power circuitry 304 associated with an electromagnetic valve system 10.

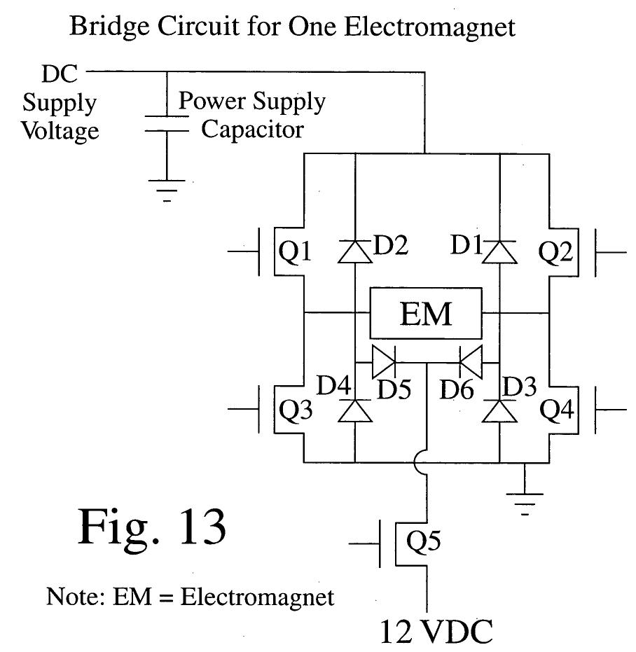

FIG. 13 is a schematic of the transistor circuitry used to energize the electromagnets and control valve position. This circuit has the following features:

Repel clapper by energizing Q1 and Q4.

Attract clapper by energizing Q2 and Q3.

Q3, Q4, and Q5 have current flow sensing capability.

Energizing Q3 and Q4 shorts the electromagnet. This feature is useful for determining clapper speed and for slowing down an approaching clapper.

Energizing Q5 can be used to feed current back to the battery as the clapper is approaching an electromagnet. This is intended as a ‘regenerative braking” feature.

For energy conservation, diodes D1, D2, D3, and D4 feed current spikes back to the supply capacitor whenever transistors Q1, Q2, Q3, Q4 are turned off and an inductively induced current spike occurs.

System Advantages. The electromagnetic valve systems 10 can be used for a wide variety of applications. The electromagnetic valve system 10 is able to controllably open and or close a valve 12 at any time, and is not mechanically limited to camshaft and/or a crankshaft.

The opening and/or closing of valves 12 is readily accomplished at any time within an engine cycle. Furthermore, one or more valves 12 are readily latched in either an open or a closed position, such that one or more cylinders may readily be disabled.

In applications for an internal combustion engine, valve timing and duration is readily controlled and modified. For example, in some engine applications, the electromagnetic valve system provides real-time profiling of valve operation, such as to provide longer valve duration, to alter valve timing for opening and/or closing.

Valve trains in conventional engines are linked through a camshaft to the crankshaft of the engine, such that operation of the valve train is inherently linked to the crankshaft speed. In contrast, the electromagnetic valve system is inherently independent of the speed the engine.

During a steady state operation of an engine, e.g. at a constant load and speed, the electronic valve system can readily operate in a somewhat conventional manner, whereby the opening and closing of valves is synchronized to the crankshaft speed.

In contrast to conventional valve systems, however, the electromagnetic valve system is readily controlled for any different operation conditions, such as for changes in ambient temperature, pressure, humidity, internal friction, and/or combustion variability.

The electromagnetic valve system 10 is also readily controlled for differing demands for power and/or torque, demands for acceleration or deceleration.

Furthermore, the time to open and/or close a valve 12 in a conventional engine is mechanically linked to a cam profile which is determined by engine speed. In contrast, the time to open and/or close a valve 12 in the electromagnetic valve system 10 is independent of the mechanical limitations of a cam and is independent of engine speed. The transit time, the time to open or close a valve 12, is controllable in the electromagnetic valve system 10, whereby a latched valve 12 is readily released and moved to an opposite position 20. In some preferred embodiments of the electromechanical valve system 10, the initial release of a valve 12 is enhanced by a strong electromagnetic pulse, to quickly accelerate the clapper 26 from the latched position.

Therefore, the time to open or close as valve 12 is readily minimized in the electromagnetic valve system 10, and is independent of engine speed, whereby the valve open period is readily and precisely controlled, such that a cylinder can be filled with an air-fuel charge more completely and fully, which at a low engine speed in some embodiments, provides a higher torque output, e.g. 15-20 percent, as compared to a conventional cam-driven engine.

In the electromagnetic valve system 10 (see FIG. 10), the speed at which a valve 12 is opened and closed is determined by the applied power to the latching electromagnet. Therefore, while there is an advantage to opening and/or closing a valve rapidly, the applied energy is typically increased to provide a fast release from a latched position. In some embodiments of the electromagnetic control system 302 (FIG. 11), a desired valve speed and energy consumption maximum is determined, to provide sufficient valve speed while conserving applied energy.

Soft Landing. As described above, as the valve approaches an endpoint 20, such as an open position 20b or a closed position 20a, the applied forces on the valve assembly 195 include the opposing force applied by the spring 28,30, e.g. the valve spring 28, and the attractive magnetic force between the clapper 26 and the appropriate electromagnet assembly 134. The attractive force of a permanent magnet 34 increases significantly at small distances 84, such that the valve 12 readily latches to the endpoint at the end of travel.

Some embodiments of the electromagnetic valve system 10 include soft landing means to prevent a hard landing of the valve assembly 195 at a latch position, whereby a small amount of energy is applied by the electromagnet 36 to provide a controlled opposing force between the permanent magnet 34 and the electromagnet 36 during landing. The resultant applied flux opposes the attractive flux of the permanent magnet 34, to provide a soft landing.

Energy Loss and Input. In the electromagnetic valve system 10, the resistance force on the landing is dependent on friction within the assembly, whereby the potential and kinetic energy of the system, from the compressed spring, is reduced, due to friction.

For example, in a system which has too much friction, the valve 12 may never reach the end of the travel, in which too much kinetic energy is lost, due to friction. Under such a condition, the clapper 26 may not reach and latch to the electromagnet 36 and permanent magnet 34, and the assembly oscillates, and energy dissipates due to friction, until the two spring forces are equal.

The electromagnetic valve system 10 therefore typically comprises means to input energy into the assembly 10, such as to provide an opposing electromagnetic flux to initiate movement of the valve 12 from a latched position, or to provide an attractive force by the appropriate electromagnet 36 at the end of travel, to assure that the assembly latches at the end position.

Electromagnetic Energy Input. In the electromagnetic valve system 10, the electromagnets are preferably used to initiate travel, i.e. to overcome the attractive force of the permanent magnet in a latch position; to input energy to the valve train, such as to promote valve speed and/or to overcome friction; to provide an attractive force to between the permanent magnet at the end of a travel; and/or to provide an opposing force at the end of a travel, to promote a soft landing.

The applied energy to the electromagnets 36 is typically controlled by the processor 302, and may comprise a variety of formats, such as steps or pulses.

The controller 302 is preferably configured to modify the applied energy, such as to compensate for operating conditions or desired performance parameters 370a-370n, such as but not limited to temperature, friction, long-time wear characteristics, seating of the valve, and/or cylinder pressure applied to the face of a valve.

Use of Electromagnets as Sensors. In some preferred embodiments of the electromagnetic valve system 10, the electromagnets 36 are also used as system sensors.

In the electromagnetic valve system 10, the clapper 26 moves in relation to the electromagnets 36. Since the permanent magnet 34 is a flux carrying element, relative movement of the clapper 26 in relation to the electromagnets 36 and/or permanent magnet 34 can be sensed by analysis of the flux at the electromagnets.

For example, the controller 302 detects the rate of change of flux, whereby the speed of the clapper 26 and valve 12 is indicated. The controller 302 determines the location from the speed at one or more points, such that the controller 302 can determine the movement and response of the valve train through one or more strokes 20a,20b.

The controller 302 preferably analyzes the movement of the valve train, and can modify the applied energy, based upon the acquired information, such as to increase energy, decrease applied energy, and/or to change the timing if applied energy, either to enhance a current operating condition, or to enhance a dynamic operating condition, e.g. to provide a different power or torque under an acceleration condition, or to conserve fuel during deceleration. Therefore, in the electromagnetic valve system 10, the magnets are preferably used both as a driving force, and as a means for sensing and control.

Active Valve Train Mass. In some embodiments of the electromagnetic valve system 10, the active mass of the electromagnetic valve assembly is equal to the combined sum of the mass of the valve 12, the mass of the clapper 26, and approximately half of each spring 28,30, Wherein one side of each spring 28,30 moves, and the opposing end of each spring 28,30 is affixed. For a spring 28,30 having a mass which is linearly distributed, the estimated active mass is approximately half that of the total mass of each spring 28,30.

The kinetic energy of the system 10 at the midpoint of motion, i.e. wherein the potential energy stored by the springs is a minimum, is approximately equal to ½ mv2.

The electromagnetic valve system 10 is described above as having a both a valve spring 28 and a disable spring 30. The assembly can also be considered to be a single, dynamic compound spring, which may also comprise the central clapper 26, which is controllable electronically to impart force, to take force out, and also to determine the speed at which the shaft is moving.

In some embodiments of the electromagnetic valve system 10, the valve train comprises both a valve spring 28 and a disable spring 30, which alternately are connected or are disconnected from the dynamic valve train 195.

During the periodic motion of the valve train, each spring 28,30 is extended from a compressed position, to a free length position. At the free length position after the interchange of energy from the moving spring to the stationary spring, the previously moving spring is isolated from the moving mass 195 of the valve train 195. In this embodiment, the springs 28,30 are fixed to the head 16 at each end, but are not affixed to the permanent magnet.

During the periodic motion of the valve train, as the clapper approaches the central region 193 of travel, the clapper 26 approaches and contacts the approaching spring which is at a resting, i.e. free length, position. When the clapper contacts the oncoming spring 28,30, the clapper 26 briefly contact with both springs 28,30, whereby the kinetic energy of the system is transferred, and the valve 12 and clapper 26 continue to move, while compressing the second spring 28,30, toward the second end 20, e.g. toward the open position 20b.

The dynamic valve assembly 195 exchanges kinetic energy within the central region 193, such as through an impact, or through a small overlapping region, e.g. wherein the first spring is almost fully extended, and wherein the second spring begins to be compressed.

In embodiments of the electromagnetic valve system 10 in which springs 28,30 are periodically isolated from the dynamic valve train 195, there is a reduction in the mass of the valve train 195. In addition, there is a reduction in spring friction for the system, since the springs are periodically isolated from the motion of the valve train 195.

Geometry Considerations. In addition to improvements in dynamic valve train mass and response, some preferred embodiments of the electromagnetic valve system 10, such as seen in FIG. 3, provide design freedom within an engine environment. The stationary permanent magnets 34 can be provided in a wide variety of form factors, such as a rectangular structure, to provide a greater magnetic flux field than a system having axial restrictions, e.g. such as for a cylindrical movable permanent magnet.

In the head of typical engine there is typically a fixed distance between the centerline of an exhaust valve 102 and the centerline of the intake valve 102. For a fixed separation distance, the alternate electromagnetic valve system 10 seen in FIG. 3 provides design flexibility, since the stationary permanent magnets can be configured across the cylinder head, e.g. such as perpendicular to the line between valve centerlines.

Magnet Composition and Performance. The magnets used for different system embodiments 10 are comprised of a wide variety of magnetic materials, such as suited for the desired thermal environment. In some preferred embodiments of the electromagnetic valve system 10, the permanent magnets 34 are comprised of neodymium. In some high temperature engine environments, the permanent magnets 34 are comprised of samarium cobalt.

In one embodiment, the present magnet 34, fully seated, with no air gap, provides a latching force of 124 pounds. In another embodiment, square (1.25 inch by 1.25 inch) stationary permanent magnets 34 provide a latching force of about 320 lbs. Those skilled in the art will appreciate that any range of force may be provided as appropriate.

In the electromagnetic valve system 10, the preferred use of permanent magnets 34 having high magnetic flux properties provides light valve train mass, as well as corresponding fast valve train response times, such as stroke times approaching 1-2 milleseconds.

The dynamic mass 195 of the valve train includes both that of the valve spring 28 and the disable spring 30 for only a brief transition region 193 in the center of travel, when both springs 28,30 are close to their released free-length position, and where the kinetic energy of the valve train is high, and wherein the stored potential energy of the springs is low.

While some embodiments of the electromagnetic valve system 10 may have a transition length equal to zero, in most system embodiments, there is a transition region 193 greater than zero, such that a smooth energy transfer occurs between the first dynamic portion 195 and the second dynamic portion 195, i.e. as energy is transferred between springs 28,30.

Movement of the electromagnetic valve system 10 from the open position 20b to the closed position 20a is similar to the actions required to move the electromagnetic valve system from the closed position 20b to the open position 20a. Electromagnetic energy is applied to the latching electromagnetic coil 36, such that the stored potential energy in the valve spring 28 overcomes the latching force. The valve train 195 moves toward the closed position 20a, wherein energy may be controllably applied to increase the attractive force at the closing end, as the disable spring is compressed. As before, energy to the electromagnetic coil 36 may be applied at the closing end, to provide a soft landing in the closed position 20a.

At either end of movement, additional energy may controllably be applied by the electromagnetic coils, such as to compensate for friction within the system. For example, the applied energy may provide an electromagnetic force which aids the permanent magnet to the latch position, by pulling the clapper 26 into a latch position, within the last portion of travel, in the closing and/or opening direction, e.g. for the last 0.010 to 0.020″.

Therefore, control of the electromagnetic valve system 10 is extremely versatile, allowing: controlled opening and closing of a valve, independent of engine crankshaft position; assisted latch completion and/or release, and preferably providing a soft landing. Based on information from previous valve train movement, the electromagnetic valve system 10 can be dynamically adjusted, such as to after valve timing and/or duration, and/or to adjust opening and/or closing energy parameters.

Electric Energy Storage. Some preferred embodiments of the electromagnetic valve system 10 provide electrical energy exchange between the mechanical valve train and an energy storage system which is connected to the electromagnetic coils, whereby the energy efficiency of the system is improved.

The energy storage module 370 shown in FIG. 12 may comprise an LC circuit 372, comprising an inductor 374 and a capacitor 376. Stored energy from the capacitor 376 is released from the circuit to the electromagnetic coil 36. Similarly, excess system energy is recovered from the electromagnetic coil 36, by storage into the capacitor 76. In conditions where the electromagnetic valve system needs more energy, more energy is applied to the capacitor 376, such that the increased energy 356 is released to the electromagnetic coil 356.

In some system embodiments 10, the electrical oscillation 378 of the LC circuit is preferably matched to the mechanical oscillation of the valve train 10. Based on system operation, the proper level of energy stored in the capacitor 376 is adjusted.

Feed forward and Feed backward Control. The electromagnetic valve system 10 is preferably controllable for steady state operation as well as for changing operation conditions. For example, for conditions which require more or less torque, the operation curves of valve timing and/or duration are readily controlled.

In some system embodiments, a map is provided and stored of the dynamic characteristics of the engine under different controllable parameters. Based upon the map and desired engine operation, the controller 302 may readily change the operating parameters of the electromagnetic valve system 10, to achieve the desired result.

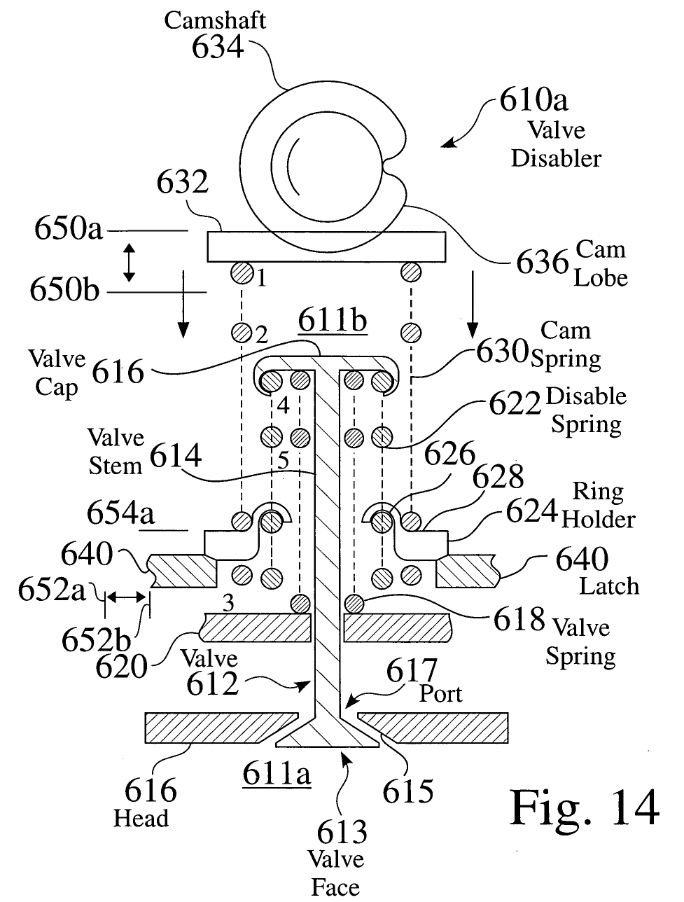

Mechanical Valve Disabler System. FIG. 14 is a detailed partial cross-sectional view of a valve disabler system 610a. A valve 612 is moveable in relation to a head 616 having a valve port 617. The valve comprises a valve face 613 at a first end 611a, which is sealable in relation to a valve seat 615. The valve 612 also includes a valve stem 614 which extends from the first end 611a to a second end 611b. A valve cap 616 is located at the second end 611b, such as a valve cap assembly 616, e.g. comprising a cap & retainers.

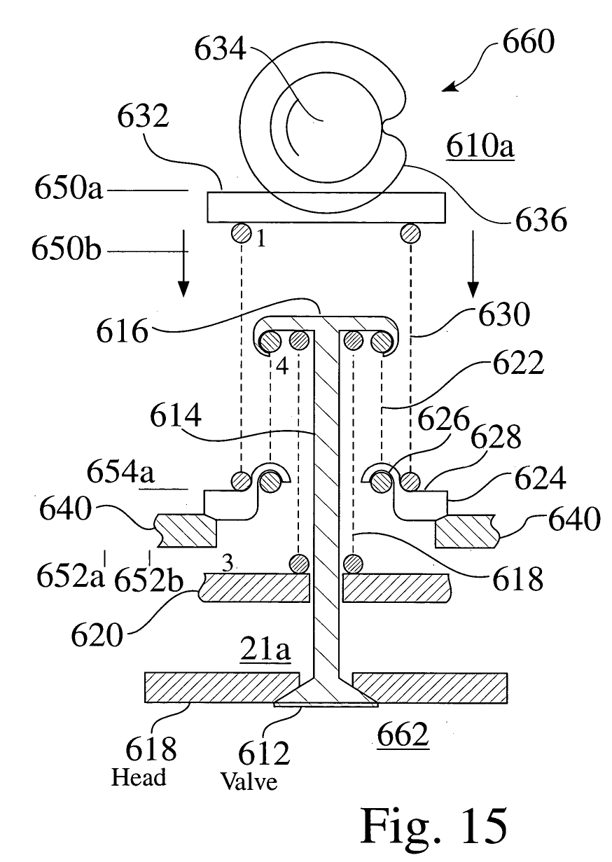

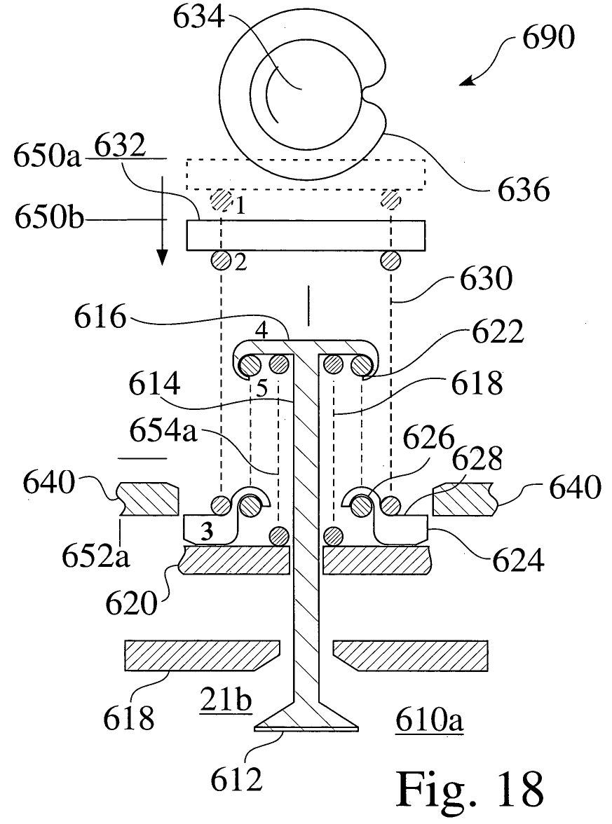

A valve spring 618 provides a compressive force between the valve 612 and a spring landing 620, which may be an integral portion of the head 616. The valve spring 618 retains the valve 612 in a normally closed position 21a (FIG. 15) in relation to the head 616. When the valve 612 extends toward an open position 21b (FIG. 18), the compression of the valve spring 618 provides a bias force against the valve cap 616.

A disable spring 622 is also affixed to the valve cap 616, and provides tension to controllably open the valve 612. The disable spring 622 is also affixed to a ring holder 624, such as by a first holder landing 626. A cam spring 630 is located between the ring holder 624, such as by a second holder landing 628, and controllably provides a compressive force between the ring holder 624 and a movable cam cap 632. A rotatable camshaft 634, having a cam lobe 636, controllably acts upon the cam cap 632, to compress the cam spring 630.

The valve disabler system 610a includes a disabler latch 640, which is movable between an unlatched, i.e. valve enabled, position 652a, and a latched, i.e. valve disabled, position 652b. In FIG. 14, the disabler latch 640 is in a latched position, such that rotation of the camshaft 634 does not result in movement of the valve 612 toward an open position 21b (FIG. 18).

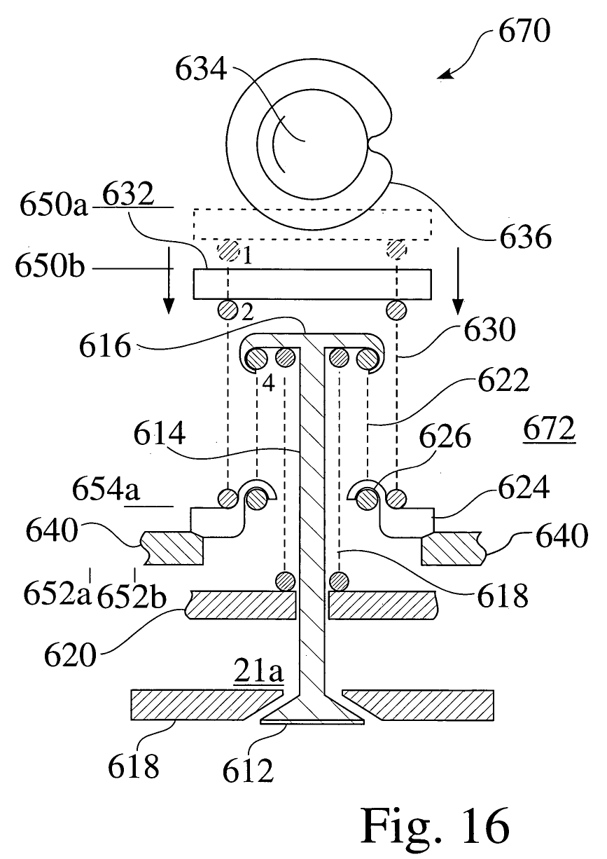

FIG. 15 is a partial cutaway view 660 of a valve disabler system 610a in an uncompressed, disabled state 662. FIG. 16 is a partial cutaway view 670 of a valve disabler system 610a in a compressed, disabled state 672. As seen in FIG. 15 and FIG. 16, when the ring holder 624 is confined by the latched position 652b by the disable latch 640, rotation of the camshaft 634 does not result in the opening of the valve 612.

As seen in FIG. 16, the cam lobe profile 636 acts to push the cam cap 632 from a top position 650a toward a lower position 650b, which compresses the cam spring 630. However, the ring holder 624 is prevented from vertical movement, by the disable latch 640 being located in the locked position 652b. During disablement 652b, the valve 612 remains closed 21a.

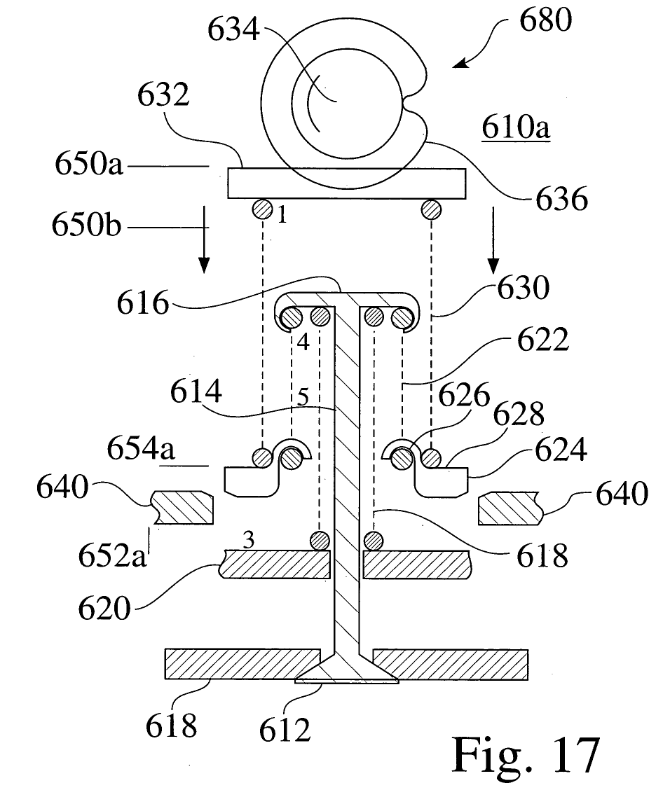

FIG. 17 is a partial cutaway view 680 of a valve disabler system 610a in an uncompressed, enabled state 682. FIG. 18 is a partial cutaway view 690 of a valve disabler system 610a in a compressed, enabled state 692. As seen in FIG. 17 and FIG. 18, when the ring holder 624 is not confined, due to the enabled position 652a of the disable latch 640, rotation of the camshaft 634 results in the opening 21b of the valve 612.

As seen in FIG. 18, the cam lobe profile 636 acts to push the cam cap 632 from a top position 650a toward a lower position 650b, which compresses the cam spring 630. When the disable latch 640 is in the enable position 652a, the ring holder 624 is allowed to move vertically.

As seen in FIG. 15, as the camshaft 634 rotates, the extended lobe region 636 of the camshaft 634 acts upon the cam spring cap 632 and cam spring 630, to compress the cam spring 630. The ring holder 624, which is in contact with the second lower end of the cam spring 630, moves downward in reaction to the compressive force from the cam spring 630, since the disable latch 640 is in the open “valve enabled” position 652a. The lower end of the disable spring 622 is also connected to the ring holder 624, such that the reactive downward movement of the ring holder creates tension in the disable spring 622. The valve 612 is vertically affixed to the upper second end of the disable spring 622, such that the valve opens 21b in reaction to tension in the disable spring 622, whereby the valve face 613 extends from the valve seat 615.

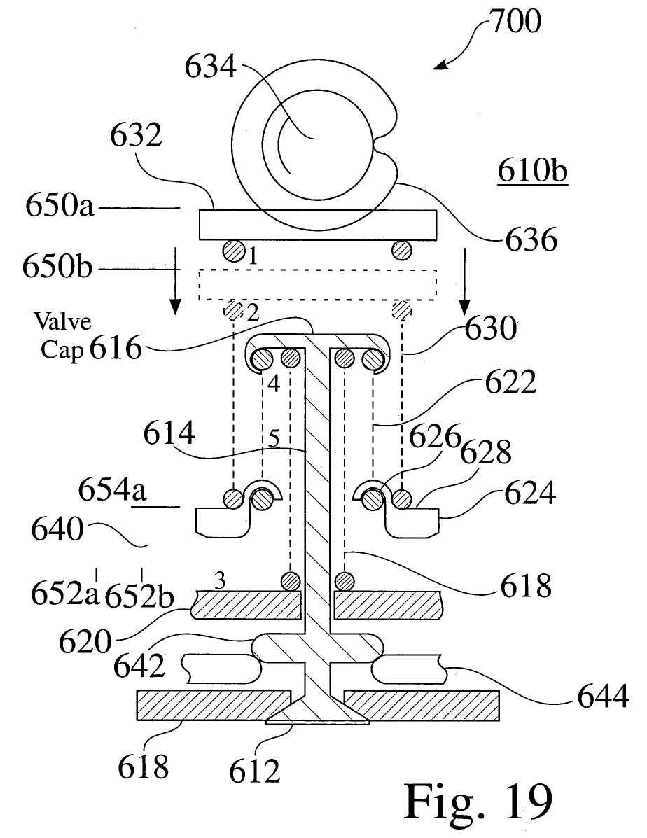

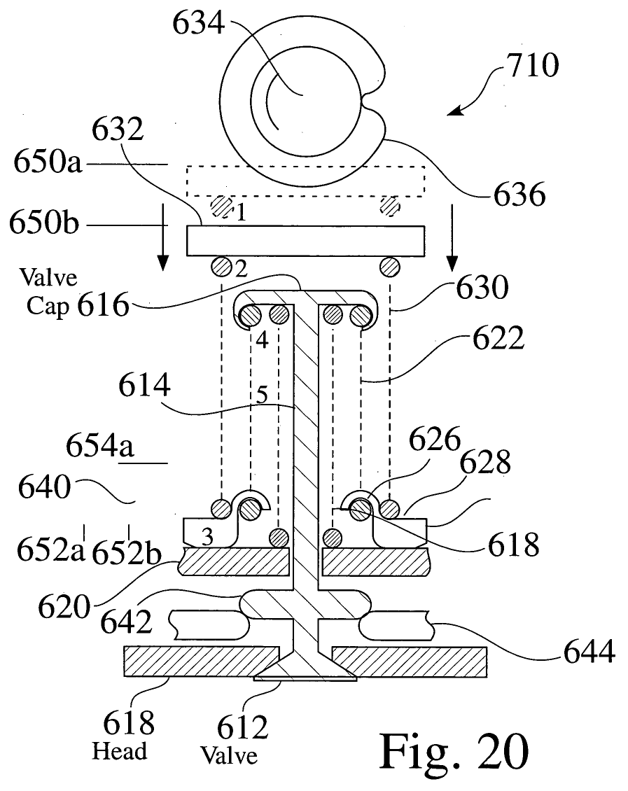

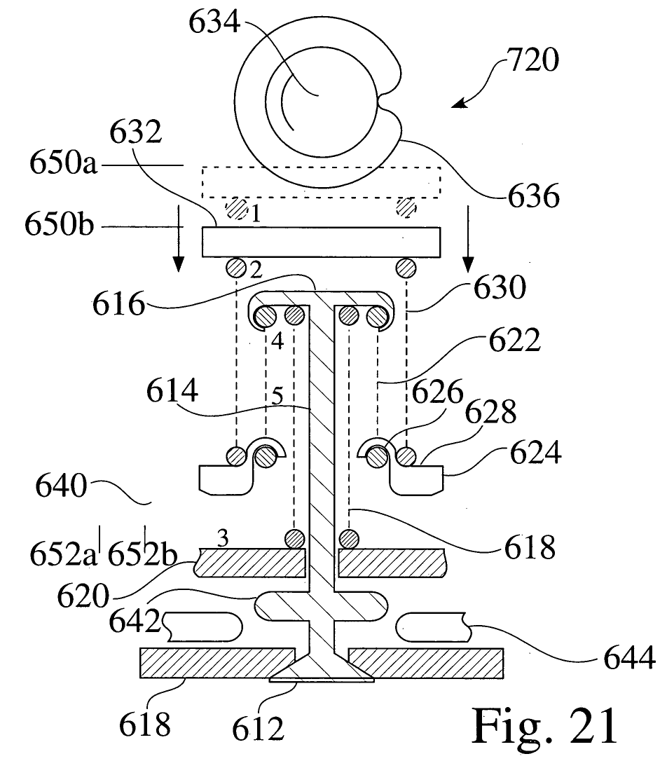

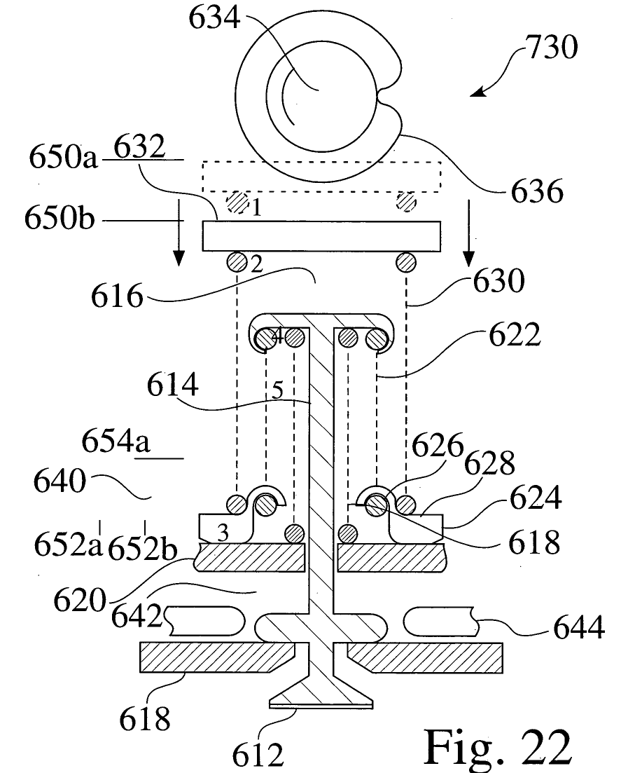

Alternate Mechanical Valve Disabler System. FIG. 19 is a detailed partial cross-sectional view 700 of an alternate mechanical valve disabler system 610b in a first position with a disabler set. FIG. 20 is a detailed partial cross-sectional view 710 of an alternate mechanical valve disabler system 610b in a second disabled position with a disabler set. FIG. 21 is a detailed partial cross-sectional view 720 of an alternate mechanical valve disabler system 610b in a first enabled and closed position. FIG. 22 is a detailed partial cross-sectional view 730 of an alternate mechanical valve disabler system 610b in a second enabled and opened position.

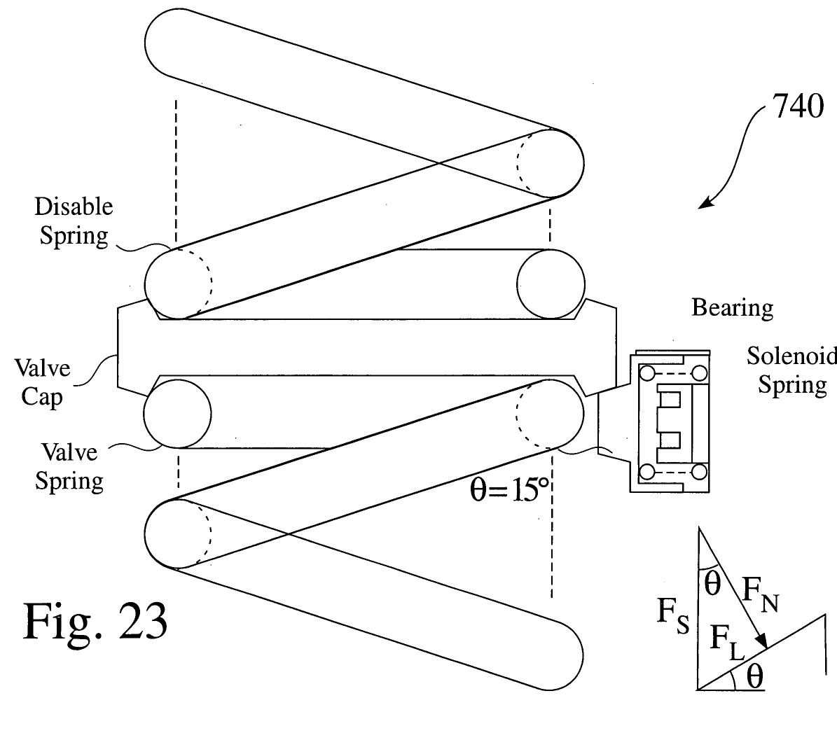

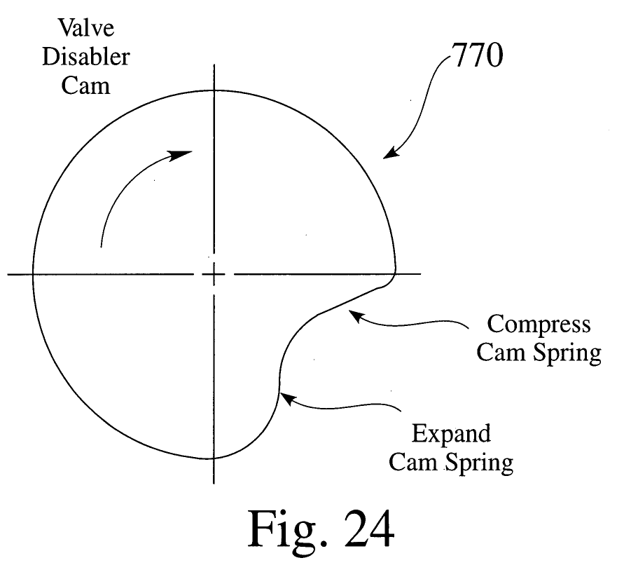

Disabler Details. FIG. 23 is a detailed partial cross-sectional view 740 of a spring disabler mechanism 742 in contact with a valve cap 744 located between a valve spring 28 and a disable spring 30. FIG. 24 is a schematic profile 770 of a disabler cam lobe 772.

The lobe 772 is preferably designed to accelerate the disable spring 30 and disable spring holder down with just enough forced delivered during approximately one sixth turn of a camshaft 34, so as to reach a fully compressed position with zero speed (as is done with the conventional camshaft/poppet valve system). In some embodiments, ¼ revolution is sufficient, since no deceleration is required.

The disabler solenoid 742 is released as soon as the disabler spring holder 744 begins to move downward, allowing the clapper to move along the outer surface of the holder. When the disabler spring holder reaches the lower zero speed point, the rebound spring pushes the clapper along the outer surface of the holder, locking it in place.

FIG. 23 shows the angled locking surface for both the valve cap and disabler spring holder. The angle theta of the surface determines the proportion of the disabler spring force, where Fx=Fz sine theta, which the solenoid spring must exert, to prevent the disabler spring from pushing up the holder.

The solenoid, when energized, overcomes the solenoid spring force, and allows the disabler spring holder to move up. The disabler spring is restrained from moving up to hold the spring compressed. The lobe surface restrains the holder in the up position. FIG. 24 is a profile view of a reverse profile cam lobe.

Presently Preferred Embodiment of the Invention

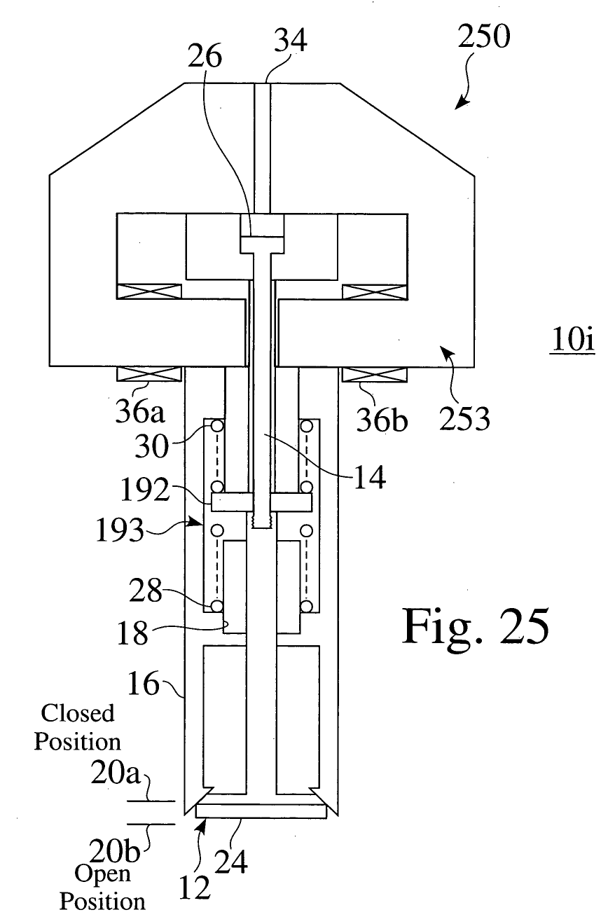

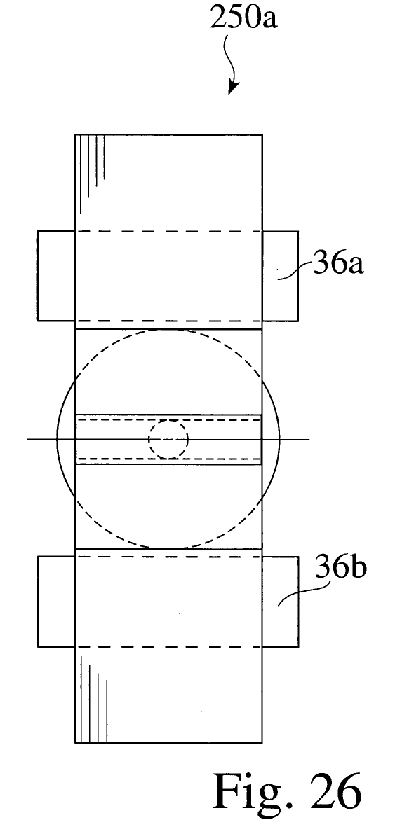

FIG. 25 is a cutaway view 250 of an electromagnetic valve actuation system 10i comprising discrete spring and electromagnet assemblies, with the valve 12 in a closed position 20a. FIG. 26 is a top schematic view 250a of the electromagnetic valve actuation system 10i comprising discrete spring and electromagnet assemblies 36a, 36b. While two electromagnets are shown, a single electromagnet may be used. In the preferred embodiment, both electromagnets are actuated together.

A spring keeper 192 affixed to the valve stem 14 moves linearly to transfer energy between the disable spring 30 and the valve spring 28. A clapper 26 affixed to the valve stem 14 moves between a magnet assembly 34 and electromagnet assemblies 36a, 36b. In this embodiment, the valve stem is a compound structure that has a portion with a threaded end which engages with another portion which has complementary threads. The magnet assembly 34 comprises a permanent magnet. Note that in some embodiments, both a north pole of the permanent magnet and a south pole of the permanent magnet are used to attract or repel said electromagnet.

As seen in FIG. 25, the springs 28,30 are preferably fastened by their ends farthest from the keeper 192, and are not fastened to the spring keeper 192, such that the springs 28,30 are preferably isolated from the dynamic mass of the valve system 10i during a portion of the valve movement. In one exemplary embodiment, the springs 28,30 are rated at 660 lbs./per inch. In the electromagnetic valve system 10i, the valve stem shaft is non-magnetic.

The permanent magnet 34 provides a latching means for the clapper 26, in either the closed position 20a or the open position 20b. As seen in FIG. 25, the permanent magnet 34 holds the valve spring 28 compressed in the valve open position 20b, whereby the valve spring 28 retains a high level of potential energy.

From the closed position 20a, wherein the clapper 26 is latched against the poles encompassing permanent magnet 34, an applied energy to the electromagnets 36a, 36b is controllably energized to release the clapper from the closed position 20a. Upon activation of energy to the electromagnets 36a, 36b, an electromagnetic flux is generated by the electromagnets 36a, 36b, which opposes the permanent magnet flux of the permanent magnet 34. When the applied opposing electromagnetic flux reduces the permanent magnet holding force below that of the spring force applied b y the disable spring 30, the valve 12 begins to open.

As the valve 12 begins to open, the applied force of the permanent magnet 34, which has a constant flux, is reduced. As the valve 12 opens and the clapper 26 moves away from the permanent magnet 34, whereby the applied flux density from the permanent magnet 34 falls off very rapidly, such that the attractive force decreases rapidly.

As the spring keeper 192 moves and advances toward the middle region 193, the spring forces are equal, and the kinetic energy of the system reaches a maximum. The spring keeper 192 continues to move, a whereby the kinetic energy of the moving mass of the assembly is converted to stored potential energy in the valve spring 28. The moving mass of the assembly is typically equal to the combined mass of the clapper 26, the valve 12, the keeper 192, and at least a portion of the springs 28,30.

In preferred embodiments of the electromagnetic actuation system 10, the kinetic mass of the valve train is minimized by the configuration of the valve spring 28 and the disable spring 30, whereby kinetic energy is transferred between the valve spring 28 and the disable spring 30, in a central region 193 of movement, and whereby the mass of either the first or second spring 28,30 is substantially isolated from the effective mass of valve train for a portion of movement.

For example, as seen in FIG. 25, as the spring keeper 192 moves beyond the central region 193, the valve spring 28 is compressed by further downward movement of the valve assembly, comprising the clapper 26, the valve 12, and spring keeper 192, while the disable spring 30 becomes isolated from the assembly (FIG. 25).

When the valve assembly approaches the end of travel, e.g. such as toward an open position 20b, the valve 12, clapper 26, and spring keeper 192 decelerate, as the kinetic energy of the valve assembly is transformed to stored potential energy in the valve spring 28. Near the limit of travel, the applied flux from the electromagnets 36a, 36b provide an attractive force to latch the valve 12 in the open position 20b.

As described above, the attractive force from between the permanent magnet 34 and the electromagnets 36a, 36b is proportional to the displacement distance, i.e. there is a strong attractive force at the very end region of travel. In preferred embodiments of the invention, therefore, energy may be controllably applied to the approaching electromagnets 36a, 36b, to promote a ‘soft’ landing.

When the spring keeper 192 compresses the valve spring 28 to the bottom limit of movement, i.e. wherein the clapper 26 approaches the armature 253 of the electromagnets 36a, 36b, the clapper 26 contacts and latches to the electromagnet assembly core because the magnet force increases as the clapper 26 approaches the electromagnets 36a, 36b. At the limit of travel, the magnetic holding force is larger than the opposing valve spring force, such that the valve 12 latches in the open position 20b. In the invention, the core may be made of solid or laminated materials. Where a laminated material is used for the core, the clapper may also be made of a laminate, preferably a continuous spiral to match the flux of the core. A laminated structure is less expensive to build and lighter in weight, and resists the generation of eddycurrents which distort the flux distribution and loses energy. In this embodiment, the preferred permanent magnet has dimensions of 3/16″×1 ½″×1½″.

In the electromagnetic valve system 10i shown in FIG. 25 and FIG. 26, the valve 12 latches in either the closed position 20a or in the open position 20b, with the application of minimal energy.

Release from either latch condition is controllable through applied energy signal, such as from an external control 302 (FIG. 11, FIG. 12). As seen in FIG. 12, an external controller 302 sends a signal, i.e. energy pulse, to the electromagnets 36a/b, which is latched to the clapper 26. The applied pulse overcomes the permanent magnet attraction force, such that the compressed spring, e.g. the valve spring 28, acts upon the assembly, which moves toward the opposite position.

Although the valve disabler system and its methods of use are described herein in connection with an engine, such as an internal combustion engine, the apparatus and techniques can be implemented for a wide variety of alternate internal combustion and/or hybrid engines, or any combination thereof, as desired. Furthermore, the apparatus and techniques can be implemented for a wide variety of valves and/or actuators, or any combination thereof, as desired.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

Although the valve system and its methods of use are described herein in connection with an engine, such as an internal combustion engine, the apparatus and techniques can be implemented for a wide variety of alternate internal combustion and/or hybrid engines, or any combination thereof, as desired. Furthermore, the apparatus and techniques can be implemented for a wide variety of valves and/or actuators, or any combination thereof, as desired.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

1. A valve system, comprising:
a valve comprising a valve stem linearly movable between a first closed position and a second, open position;
a first spring;
a second spring;
a first electromagnet assembly;
a second electromagnet assembly; and
a permanent magnet clapper affixed to the valve stem;
whereby the first spring is compressed and the valve is moved toward the first closed position as the permanent magnet approaches the first electromagnetic assembly, and whereby the second spring is compressed and the valve is moved toward the second open position as the permanent magnet approaches the second electromagnetic assembly.

2. The valve system of claim 1, further comprising:
means for providing energy to at least one of the electromagnet assemblies to increase a local magnetic field.

3. The valve system of claim 1, further comprising:
means for providing energy to at least one of the electromagnet assemblies to decrease a local magnetic field.

4. The valve system of claim 1, further comprising:
means for providing energy to at least one of the electromagnet assemblies to attract the permanent magnet.

5. The valve system of claim 1, further comprising:
means for providing energy to at least one of the electromagnets to repel the permanent magnet.

6. The valve system of claim 1, further comprising:
means for repelling and attracting said clapper as needed to allow said valve to be opened and/or closed more quickly than a natural frequency of a spring mass combination would perform while still obtaining a soft landing.

7. The valve system of claim 1, further comprising:
means for feedback control of valve motion to allow for compensation of friction, pressure forces, and other forces.

8. The valve system of claim 1, further comprising:
means for energy recovery during deceleration of said valve.

9. The valve system of claim 1, wherein overall power consumption is low because no power is required to hold said valve open or closed.

10. The valve system of claim 1, further comprising:
means for storing energy recovered from at least one of the electromagnet assemblies.

11. The valve system of claim 1, wherein the permanent magnet comprises neodymium.

12. The valve system of claim 1, wherein the permanent magnet comprises samarium cobalt.

13. The valve system of claim 1, wherein said first spring is isolated from said valve at the first closed position, and wherein said second spring is isolated from said valve at the second open position.

14. A valve system, comprising:
a valve assembly linearly movable between a closed position and an open position;
a valve spring which is compressed by the valve assembly when the valve assembly is located in the open position, and is uncompressed when the valve assembly is located in the closed position;
a disable spring which is compressed by the valve assembly when the valve assembly is located in the closed position, and is uncompressed when the valve assembly is located in the open position;
a first electromagnet and a second electromagnet;
a first permanent magnet located proximate to the first electromagnet;
a second permanent magnet located proximate to the second electromagnet; and
a clapper affixed to the valve assembly, such that the clapper moves between the first electromagnet and the second electromagnet.

15. The valve system of claim 14, further comprising:
means for providing energy to at least one of the electromagnets to increase a local magnetic field.

16. The valve system of claim 14, further comprising:
means for providing energy to at least one of the electromagnets to decrease a local magnetic field.

17. The valve system of claim 14, further comprising:
means for providing energy to at least one of the electromagnets to attract the clapper.

18. The valve system of claim 14, further comprising:
means for providing energy to at least one of the electromagnets to repel the clapper, when said clapper comprises a permanent magnet.

19. The valve system of claim 14, further comprising:
means for storing energy recovered from at least one of the electromagnets.

20. The valve system of claim 14, wherein the permanent magnet comprises neodymium.

21. The valve system of claim 14, wherein the permanent magnet comprises samarium cobalt.

22. The valve system of claim 14, wherein the valve spring is isolated from the valve at the closed position, and wherein the disable spring is isolated from the valve at the open position.

23. A valve system, comprising:
a valve assembly linearly movable between a closed position and an open position;
a valve spring which is compressed by the valve assembly when the valve assembly is located in the open position, and is uncompressed when the valve assembly is located in the closed position;
a disable spring which is compressed by the valve assembly when the valve assembly is located in the closed position, and is uncompressed when the valve assembly is located in the open position;
at least one electromagnet;
at least one permanent magnet; and
a clapper affixed to the valve assembly and movable in relation to the electromagnet and the permanent magnet.

24. The valve system of claim 23, further comprising:
means for providing energy to at least one of the electromagnets to increase a local magnetic field.

25. The valve system of claim 23, further comprising:
means for providing energy to at least one of the electromagnets to decrease a local magnetic field.

26. The valve system of claim 23, further comprising:
means for providing energy to at least one of the electromagnets to attract the clapper.

27. The valve system of claim 23, further comprising:
means for providing energy to at least one of the electromagnets to repel the clapper, wherein said clapper comprises a permanent magnet.

28. The valve system of claim 23, further comprising:
means for storing energy recovered from at least one of the electromagnets.

29. The valve system of claim 23, wherein the permanent magnet comprises neodymium.

30. The valve system of claim 23, wherein the permanent magnet comprises samarium cobalt.

31. The valve system of claim 23, wherein the valve spring is isolated from the valve at the closed position, and wherein the disable spring is isolated from the valve at the open position.

32. The valve system of claim 23, wherein energy is returned to a power source by use of regenerative breaking of said clapper.

33. The valve system of claim 23, wherein both a north pole of said permanent magnet and a south pole of said permanent magnet are used to attract or repel said electromagnet.

34. The valve system of claim 23, further comprising:
a software module for at least partially controlling a soft landing and optionally for reducing power consumption.

35. The valve system of claim 23, further comprising:
means to open said valve partially and close it again.

36. The valve system of claim 23, wherein the valve spring and the disable spring each have a different rate of compression.

37. The valve system of claim 23, further comprising:
an electromagnet core.

38. The valve system of claim 37, wherein said core is formed as a laminated structure.

39. The valve system of claim 37, wherein said clapper is formed as a spiral laminate structure.

40. The valve system of claim 23, wherein the valve spring and the disable spring have different lengths.

41. The valve system of claim 23, wherein the valve spring and the disable spring have different masses.
